(19) United States
(12) Patent Application Publication
(10) Pub. No.: US 2009/0059106 A1
(43) Pub. Date: Mar. 5, 2009

(54) LIQUID CRYSTAL DEVICE, DRIVING METHOD OF LIQUID CRYSTAL DEVICE, INTEGRATED CIRCUIT DEVICE FOR DRIVING LIQUID CRYSTAL DEVICE, AND ELECTRONIC APPARATUS

(75) Inventors: Kazuma Kitadani, Chino-shi (JP); Daisuke Sato, Chino-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/194,073

(22) Filed: Aug. 19, 2008

(30) Foreign Application Priority Data
Aug. 31, 2007 (JP) 2007-226376
Sep. 19, 2007 (JP) 2007-242288

(51) Int. Cl. G02F 1/133

(52) U.S. Cl. 349/33

(57) ABSTRACT

A liquid crystal device includes a first substrate and a second substrate disposed in a mutually opposing relationship and liquid crystals sandwiched between the first substrate and the second substrate. When an initial sequence is executed, an alignment state of molecules of the liquid crystals transitions from a splay alignment state to a bend alignment state to thereby perform display or light modulation. The liquid crystal device further includes a plurality of scanning lines and a plurality of data lines formed on the first substrate so as to intersect each other; a pixel circuit including switching elements formed at intersections of the plurality of scanning lines and the plurality of data lines, pixel electrodes connected to the switching elements, and sustain capacitors for temporarily sustaining voltages of the pixel electrodes; opposing electrodes formed on the second substrate opposite the pixel electrodes; a driver capable of driving the scanning lines, the data lines, and the opposing electrodes; and a control unit configured to supply a control signal and an image signal for the display or the light modulation. The initial sequence includes a bend transition nucleus generation sequence and a bend transition expansion sequence. A horizontal electric field is generated by a potential

difference between the pixel electrodes and the scanning lines during execution of the bend transition nucleus generation sequence. A vertical electric field is generated by a potential difference between the pixel electrodes and the opposing electrodes during execution of the bend transition expansion sequence,

### CROSS REFERENCES TO RELATED APPLICATIONS

The present invention contains subject matter related to Japanese Patent Application Nos. 2007-226376 and 2007-242288 filed in the Japanese Patent Office on Aug. 31, 2007 and Sep. 19, 2007, respectively, the entire contents of which are incorporated herein by reference.

### BACKGROUND

1. Technical Field

The present invention relates to a liquid crystal device (e.g., a liquid crystal device using OCB liquid crystals), a driving method of the liquid crystal device, an integrated circuit device for driving the liquid crystal device, and an electronic apparatus.

2. Related Art

In the field of liquid crystal devices typified by liquid crystal televisions and liquid crystal projectors, there are increasing demands for improvement in the quality of moving images as well as still images, and it is thus necessary to increase a response speed of the liquid crystal devices. In recent years, therefore, liquid crystal devices using OCB liquid crystals (hereinafter referred to as OCB-mode liquid crystal devices) with fast response speed have attracted a lot of attention.

In such OCB-mode liquid crystal devices, liquid crystal molecules change their alignment from an initial-state alignment to a display-state alignment. In an initial state, the alignment of the liquid crystal molecules is regulated such that they are splayed out between two substrates (such an alignment state is called a splay alignment state). On the other hand, in a display state, the alignment of the liquid crystal molecules is regulated such that they bend like a drawn bow between two substrates (such an alignment state is called a bend alignment state).

When image display or light modulation is performed on the OCB-mode liquid crystal devices, a driving voltage is applied in the bend alignment state. In the bend alignment state, the transition of the alignment of the liquid crystal molecules at the time of voltage application takes place faster than that of a TN mode or a STN mode. Therefore, a light transmission rate of a liquid crystal layer can be changed quickly, and thus a fast response speed can be provided.

The OCB liquid crystals are in a splay alignment state when a voltage is not applied thereto and transition to a bend alignment state, for example, when a high voltage is applied thereto. When a display operation is to be performed on the OCB-mode liquid crystal devices, the liquid crystal molecules need to be in the bend alignment state. Moreover, in order to cause the alignment of the liquid crystal molecules to transition from the splay alignment state to the bend alignment state, it is necessary to execute an initial sequence.

The initial sequence includes a bend transition nucleus generation sequence and a bend transition expansion sequence. That is, a nucleus for bend transition (bend transition nucleus) is first generated (bend transition nucleus generation), and thereafter, the transition is expanded peripherally (bend transition expansion).

If the initial sequence is not perfect, display defects may occur. An example of the initial sequence of the OCB-mode liquid crystal devices is described in JP-A-2001 083479, for example.

The initial sequence of the OCB-mode liquid crystal devices (including the bend transition nucleus generation sequence and the bend transition expansion sequence) generally requires high voltage application and a complex driving sequence.

Therefore, a liquid crystal driver needs to be a high-voltage device, which during manufacture of a driver IC, occupies greater space, complicates the manufacturing process, and inevitably increases the cost.

Moreover, when the initial sequence is complicated, the transition time to a displayable state after power-on is increased, and the control of the liquid crystal driver is also complicated.

From the viewpoint of improving the usability of the OCB-mode liquid crystal devices, it is desirable to implement a reasonable method that provides satisfactory results through a series of sequences: a bend transition nucleus generation sequence and a bend transition expansion sequence.

In particular, by obviating the need for application of an excessively high voltage during the initial sequence, it is possible to remarkably reduce the load to the liquid crystal driver.

Moreover, by employing a driving method similar to the driving method during a normal operation of the OCB-mode liquid crystal devices (i.e., by employing a driving method that follows the driving during a normal operation and that does not require application of an excessively high voltage and complex processing), it is possible to guarantee consistency in the driving method, reduce the load to the liquid crystal driver, and reduce the cost. Moreover, it is possible to obviate the need for a special process completely different from that of the normal operation to be performed for the initial sequence, and thus the usability of the OCB-mode liquid crystal devices is improved.

Although JP-A-2001-083479 discloses a technology that can efficiently generate a transition nucleus by means of a horizontal electric field, it is not discussed as to how the transition can be expanded in a satisfactory manner after the bend transition nucleus is generated.

### SUMMARY

An advantage of some aspects of the invention is that it provides a liquid crystal device, a driving method of the liquid crystal device, an integrated circuit device for driving the liquid crystal device, and an electronic apparatus, capable of implementing the initial sequence of an OCB-mode liquid crystal device without requiring application of an excessively high voltage. Another advantage of some aspects of the invention is that it provides a liquid crystal device, a driving method of the liquid crystal device, an integrated circuit device for driving the liquid crystal device, and an electronic apparatus, capable of implementing the initial sequence of an OCB-mode liquid crystal device by means of the same sequential driving method (e.g., a line sequential driving method and a multiline sequential driving method) as that of a normal operation. A further advantage of some aspects of the invention is that it provides a liquid crystal device, a driving method of the liquid crystal device, an integrated circuit device for driving the liquid crystal device, and an electronic apparatus, capable of simplifying a liquid crystal driving circuit and thus decreasing the cost of the OCB-mode liquid crystal device.

### Aspect 1

According to a first aspect of the invention, there is provided a liquid crystal device including a first substrate and a second substrate disposed in a mutually opposing relationship and liquid crystals sandwiched between the first substrate and the second substrate, in which an initial sequence is executed, whereby an alignment state of molecules of the liquid crystals transitions from a splay alignment state to a bend alignment state to thereby perform display or light modulation. The liquid crystal device further includes a plurality of scanning lines and a plurality of data lines formed on the first substrate so as to intersect each other; a pixel circuit including switching elements formed at intersections of the plurality of scanning lines and the plurality of data lines, pixel electrodes connected to the switching elements, and sustain capacitors for temporarily sustaining voltages of the pixel electrodes; opposing electrodes formed on the second substrate opposite the pixel electrodes; a driver capable of driving the scanning lines, the data lines, and the opposing electrodes; and a control unit configured to supply a control signal and an image signal for the display or the light modulation. The initial sequence includes a bend transition nucleus generation sequence and a bend transition expansion sequence. A horizontal electric field is generated by a potential difference between the pixel electrodes and the scanning lines during execution of the bend transition nucleus generation sequence. A vertical electric field is generated by a potential difference between the pixel electrodes and the opposing electrodes during execution of the bend transition expansion sequence.

According to the configuration of the aspect of the invention, a liquid crystal device is implemented in which a novel initial sequence (a transition sequence) is executed, in which a bend transition nucleus is generated by means of a horizontal electric field generated between the scanning lines and the pixel electrodes, and the bend transition is expanded by means of a vertical electric field. When a localized strong horizontal electric field is applied to OCB-mode liquid crystals, declination may occur, which is a defective area where alignment of the liquid crystal molecules is discontinuous and is referred to as a disclination line, and the disclination serves as the bend transition nucleus. When a strong vertical electric field is applied to the entire pixels of the OCB-mode liquid crystals after the bend transition nucleus is generated, expansion of the bend transition is started. Since the sequences for the bend transition nucleus generation and the bend transition expansion can be implemented by a normal liquid crystal driving method that controls the levels and application timings of voltages to the scanning lines, the data lines, and the opposing electrodes, it is not necessary to add a special circuit in order to implement the initial sequence. Therefore, it is possible to simplify the liquid crystal driver and to thus reduce the cost of the liquid crystal device.

### Aspect 2

A second aspect of the invention relates to the liquid crystal device according to the above aspect of the invention, in which during execution of the bend transition nucleus generation sequence, a voltage is applied to the scanning lines so that the switching elements of the pixel circuit are turned on, and a voltage different from the voltage applied to the scanning lines is applied to the data lines. During execution of the bend transition expansion sequence, different voltages are applied to the data lines and the opposing electrodes, respectively.

This aspect of the invention clearly states that during the bend transition nucleus generation sequence, a voltage (i.e., a selection voltage) capable of turning on the switching elements of the pixel circuit is applied to the scanning lines, add a voltage different from the voltage (i.e., the selection voltage) is applied to the data lines, whereby a potential difference is produced between the pixel electrodes and selected (activated) ones of the scanning lines, thereby generating a horizontal electric field. This aspect of the invention also clarifies that during the bend transition expansion sequence, the pixel electrodes and the opposing electrodes have different voltages (e.g., a voltage different from the voltage of the opposing electrodes is written to the respective pixels via the data lines), whereby a vertical electric field is applied to the entire pixels.

### Aspect 3

A third aspect of the invention relates to the liquid crystal device according to the above aspect of the invention, in which during execution of the bend transition nucleus generation sequence, a horizontal electric field is generated by a potential difference between the pixel electrodes and non-selected ones of the scanning lines.

According to the configuration of the aspect of the invention, a liquid crystal device is implemented in which a novel initial sequence (a transition sequence) is executed, in which a horizontal electric field is generated by means of a potential difference between the pixel electrodes and non-selected ones of the scanning lines, whereby the bend transition nucleus is generated by means of the horizontal electric field, and in which the bend transition is expanded by means of the vertical electric field generated between the pixel electrodes and the opposing electrodes. In particular, since the horizontal electric field generated between the pixel electrodes and the non-selected ones of the scanning lines is used during the bend transition nucleus generation sequence, it is possible to increase the total amount of energy applied to the liquid crystals in a satisfactory manner. That is, since the non-selection period of the scanning lines is longer than the selection period, it is possible to increase the application time of the horizontal electric field to the liquid crystals by using the horizontal electric field applied between the pixel electrodes and the non-selected ones of the scanning lines. Therefore, it is possible to facilitate the generation of the bend transition nucleus.

### Aspect 4

A fourth aspect of the invention relates to the liquid crystal device according to the above aspect of the invention, in which during execution of the bend transition nucleus generation sequence, a horizontal electric field is generated by a potential difference between the pixel electrodes and selected ones of the scanning lines.

According to the configuration of the aspect of the invention, the selected (activated) ones of the scanning lines as well as the non-selected (non-activated) ones of the scanning lines contribute to the generation of the horizontal electric field. Therefore, the horizontal electric field can be always (continuously) applied to the liquid crystals regardless of the selection or non-selection of the scanning lines, and thus the bend transition nucleus generation can be performed in a more efficient manner.

### Aspect 5

A fifth aspect of the invention relates to the liquid crystal device according to the above aspect of the invention, in which the potential difference between the pixel electrodes and the non-selected ones of the scanning lines is larger than the potential difference between the pixel electrodes and the selected ones of the scanning lines.

According to the configuration of the aspect of the invention, the potential difference between the pixel electrodes and the non-selected ones of the scanning lines is set larger than the potential difference between the pixel electrodes and the selected ones of the scanning lines. Due to the large potential difference, a strong horizontal electric field can be applied to the liquid crystals during a non-selection period of the scanning lines; therefore, the bend transition nucleus generation can be facilitated in a reliable manner.

### Aspect 6

A sixth aspect of the invention relates to the liquid crystal device according to the above aspect of the invention, in which the liquid crystals are OCB-mode (optically compensated bend mode) liquid crystals.

An OCB-mode liquid crystal device using the OCB-mode liquid crystals has a fast response speed. According to the configuration of the aspect of the invention, since the OCB-mode liquid crystal device is used, it is possible to obviate the need for a special process completely different from that of the normal operation to be performed for the initial sequence. Therefore, it is possible to simplify the circuit configuration of the OCB-mode liquid crystal device and miniaturize the OCB-mode liquid crystal device.

### Aspect 7

A seventh aspect of the invention relates to the liquid crystal device according to the above aspect of the invention, in which during execution of the bend transition nucleus generation sequence, identical voltages are applied to the data lines and the opposing electrodes, respectively, so that a vertical electric field is not generated between the pixel electrodes and the opposing electrodes.

For the bend transition nucleus generation to take place, it is necessary to apply a potential difference between the scanning lines and the pixel electrodes to generate a localized strong horizontal electric field. In this case, it is preferable to remove any potential difference between the pixel electrodes and the opposing electrodes so that a vertical electric field is substantially zero. That is, when an extra vertical electric field is generated, the amount of energy usable for generation of the horizontal electric field decreases. Moreover, there is a possibility that the vertical electric field may have any adverse effect on the bend transition nucleus generation. Therefore, it is desirable to set the vertical electric field to zero and to generate a localized electric field as strong as possible during the bend transition nucleus generation by means of the horizontal electric field. However, the present invention is not limited to this.

For example, in practical implementations, a slight vertical electric field may be generated due to some driving reasons. Moreover, when the scanning lines and the pixel electrodes are not at the same level due to presence of a step difference of a device, a vertical electric field component is inevitably generated when a potential difference is applied between the scanning lines and the pixel electrodes. In order to remove such a vertical electric field component, a method may be considered in which a vertical electric field is intentionally generated in a reverse direction. Such a method is also included in the technical scope of the present invention. Even when the vertical electric field is generated simultaneously with the horizontal electric field, the localized horizontal electric field is dominant, and in no cases, the vertical electric field is greater than the horizontal electric field.

### Aspect 8

An eighth aspect of the invention relates to the liquid crystal device according to the above aspect of the invention, in which during execution of the bend transition nucleus generation sequence, voltages having opposite polarities relative to a predetermined potential are applied to the pixel electrodes and the scanning lines, respectively.

For example, a first voltage of a positive polarity (a positive voltage relative to 0 V) is applied to the pixel electrodes, and a second voltage of a negative polarity (a negative voltage relative 0 V) is applied to the scanning lines. Even though the first and second voltages do not have large absolute values, because their potentials are of opposite polarities, the potential difference corresponds to the sum of the absolute values of the first and second voltages. Therefore, it is possible to increase the potential difference in a satisfactory manner. Accordingly, a strong horizontal electric field required for the bend transition nucleus generation can be generated in a satisfactory manner without needing to generate an excessively high voltage.

### Aspect 9

A ninth aspect of the invention relates to the liquid crystal device according to the above aspect of the invention, in which during execution of the initial sequence, the scanning lines are driven in a sequential manner.

According to the configuration of the aspect of the invention, the initial sequence is implemented by means of the same sequential driving method as that of a normal operation. Since a driving method that follows the driving during a normal operation and that does not require application of an excessively high voltage and complex processing is used in the initial sequence, it is possible to maintain consistency in the driving method. Therefore, it is possible to reduce the load to the liquid crystal driver and reduce the cost. Moreover, it is possible to obviate the need for a special process completely different from that of the normal operation to be performed for the initial sequence, and thus the usability of the OCB-mode liquid crystal devices is improved.

### Aspect 10

A tenth aspect of the invention relates to the liquid crystal device according to the above aspect of the invention, in which the sequential driving employs any one of the following methods: a line sequential driving method wherein the scanning lines are sequentially driven on a one-by-one basis; a multiline sequential driving method wherein the scanning lines are sequentially driven in units of multiple lines of the scanning lines that are simultaneously selected; and a field sequential driving method wherein the entire scanning lines are simultaneously driven.

The line sequential driving method is a driving method that is typically used in a liquid crystal driving. When the line sequential driving method is employed as a driving method in the initial sequence, the driving method during the initial sequence becomes identical to that during a normal operation; therefore, it is possible to maintain consistency in the driving method.

Moreover, when a multiline sequential driving can be used in a normal operation, the multiline sequential driving can be employed in the initial sequence. In such a case, it is possible to maintain consistency in the driving method during the normal operation and the initial sequence. Therefore, a high-speed driving can be realized.

Moreover, when a field sequential driving can be used in a normal operation, the field sequential driving can be employed in the initial sequence. In such a case, it is possible to maintain consistency in the driving method during the normal operation and the initial sequence. Therefore, a high-speed driving can be realized.

### Aspect 11

An eleventh aspect of the invention relates to the liquid crystal device according to the above aspect of the invention, in which the bend transition nucleus generation sequence is executed repeatedly over a plurality of frame periods.

According to the configuration of the aspect of the invention, the bend transition nucleus generation sequence is executed repeatedly over a plurality of frame periods. Therefore, a predetermined voltage can be applied to the respective pixels for a predetermined period or more, and thus the bend transition nucleus generation can be realized in a reliable manner.

### Aspect 12

A twelfth aspect of the invention relates to the liquid crystal device according to the above aspect of the invention, in which the bend transition expansion sequence is executed repeatedly over a plurality of frame periods.

According to the configuration of the aspect of the invention, the bend transition expansion sequence is executed repeatedly over a plurality of frame periods. Therefore, a predetermined voltage can be applied to the respective pixels for a predetermined period or more, and thus the bend transition expansion can be realized in a reliable manner.

### Aspect 13

A thirteenth aspect of the invention relates to the liquid crystal device according to the above aspect of the invention, in which the bend transition nucleus generation sequence is executed repeatedly over a predetermined plurality of frame periods, wherein the bend transition expansion sequence is executed repeatedly over a predetermined plurality of frame periods, and wherein a repetition period of the bend transition expansion sequence is set longer than a repetition period of the bend transition nucleus generation sequence.

According to the configuration of the aspect of the invention, since a predetermined voltage is applied to the respective pixels for a predetermined period or more, the bend transition nucleus generation and the bend transition expansion can be realized in a reliable manner. Moreover, since the bend transition expansion requires larger energy supply, the repetition period of the bend transition expansion sequence is set longer than the repetition period of the bend transition nucleus generation sequence.

### Aspect 14

According to a fourteenth aspect of the invention, there is provided a driving method of a liquid crystal device including: a first substrate and a second substrate disposed in a mutually opposing relationship; liquid crystals sandwiched between the first substrate and the second substrate; a plurality of scanning lines and a plurality of data lines formed on the first substrate so as to intersect each other; a pixel circuit including switching elements formed at intersections of the plurality of scanning lines and the plurality of data lines, pixel electrodes connected to the switching elements, and sustain capacitors for temporarily sustaining voltages of the pixel electrodes; opposing electrodes formed on the second substrate opposite the pixel electrodes, in which an initial sequence is executed, whereby an alignment state of molecules of the liquid crystals transitions from a splay alignment state to a bend alignment state to thereby perform display or light modulation. The initial sequence includes a bend transition nucleus generation sequence and a bend transition expansion sequence. During the bend transition nucleus generation sequence, a horizontal electric field is generated by a potential difference between the pixel electrodes and the scanning lines, whereby a bend transition nucleus is generated by means of the horizontal electric field. During the bend transition expansion sequence, a vertical electric field is generated by a potential difference between the pixel electrodes and the opposing electrodes, whereby bend transition is expanded by means of the vertical electric field.

According to the configuration of the aspect of the invention, a driving method of a liquid crystal device is implemented in which a novel initial sequence (a transition sequence) is executed, in which a bend transition nucleus is generated by means of a horizontal electric field generated between the scanning lines and the pixel electrodes, and the bend transition is expanded by means of a vertical electric field.

### Aspect 15

A fifteenth aspect of the invention relates to the driving method of a liquid crystal device according to the above aspect of the invention, in which during the bend transition nucleus generation sequence, a first voltage of a first polarity is applied to the scanning lines so that the switching elements are turned on, a second voltage of a second polarity opposite to the first polarity is applied to the data lines so that a potential difference corresponding to a difference between the first voltage and the second voltage is produced between the pixel electrodes and the scanning lines, thereby generating a horizontal electric field, and the second voltage of the second polarity is applied to the opposing electrodes so that a potential difference is not produced between the opposing electrodes and the pixel electrodes, thereby preventing generation of a vertical electric field, and wherein during the bend transition expansion sequence, different voltages are applied to the data lines and the opposing electrodes, respectively, so that a vertical electric field is generated by a potential difference between the pixel electrodes and the opposing electrodes.

According to the configuration of the aspect of the invention, a driving method of a liquid crystal device is implemented in which a novel initial sequence (a transition sequence) is executed, in which a bend transition nucleus is generated by means of a horizontal electric field generated between the scanning lines and the pixel electrodes, and the bend transition is expanded by means of a vertical electric field, and in which during the bend transition nucleus generation sequence, a potential difference between the opposing electrodes and the pixel electrodes is removed so that a vertical electric field is not generated.

### Aspect 16

A sixteenth aspect of the invention relates to the driving method of a liquid crystal device according to the above aspect of the invention, in which during the bend transition nucleus generation sequence, a horizontal electric field is generated by a potential difference between the pixel electrodes and non-selected ones of the scanning lines, whereby a bend transition nucleus is generated by means of the horizontal electric field.

According to the configuration of the aspect of the invention, a driving method of a liquid crystal device is implemented in which a novel initial sequence (a transition sequence) is executed, in which the bend transition nucleus is generated by means of the horizontal electric field generated between the pixel electrodes and non-selected ones of the scanning lines, and the bend transition is expanded by means of the horizontal electric field generated between the pixel electrodes and the opposing electrodes.

### Aspect 17

A seventeenth aspect of the invention relates to the driving method of a liquid crystal device according to the above aspect of the invention, in which during the bend transition nucleus generation sequence, a horizontal electric field is also generated by a potential difference between the pixel electrodes and selected ones of the scanning lines such that the potential difference between the pixel electrodes and the non-selected ones of the scanning lines is greater than the potential difference between the pixel electrodes and the selected ones of the scanning lines, voltages having opposite polarities relative to a predetermined potential are applied to the pixel electrodes and the non-selected ones of the scanning lines, respectively, and a vertical electric field is not generated between the pixel electrodes and the opposing electrodes.

According to the configuration of the aspect of the invention, the horizontal electric field can be applied to the liquid crystals during both the non-selection period and the selection period of the scanning lines (i.e., continuous voltage application is possible). Moreover, a stronger horizontal electric field can be applied during a long non-selection period, and the strong horizontal electric field during the non-selection period can be generated by application of voltages of opposite polarities to the pixel electrodes and the non-selected ones of the scanning lines, respectively. Therefore, the bend transition nucleus generation can be implemented in an extremely efficient manner. Moreover, since the vertical electric field generation is suppressed as much as possible during the bend transition nucleus generation, the bend transition nucleus can be generated in an efficient manner by means of only the strong horizontal electric field.

### Aspect 18

An eighteenth aspect of the invention relates to the driving method of a liquid crystal device according to the above aspect of the invention, in which during the initial sequence, the scanning lines are driven in a sequential manner, wherein the bend transition nucleus generation sequence is executed repeatedly over a predetermined plurality of frame periods, wherein the bend transition expansion sequence is executed repeatedly over a predetermined plurality of frame periods, and wherein a repetition period of the bend transition expansion sequence is set longer than a repetition period of the bend transition nucleus generation sequence.

According to the configuration of the aspect of the invention, since the sequential driving method is employed, it is possible to maintain consistency in the driving method during the normal operation and the initial sequence. Since the initial sequence is executed repeatedly over a plurality of frame periods, a predetermined voltage can be applied to the respective pixels for a predetermined period or more, and thus the bend transition nucleus generation and the bend transition expansion can be realized in a reliable manner. Moreover, since the bend transition expansion requires larger energy supply, the repetition period of the bend transition expansion sequence is set longer than the repetition period of the bend transition nucleus generation sequence.

### Aspect 19

According to a nineteenth aspect of the invention, there is provided an integrated circuit device for driving a liquid crystal device that execute the driving method of a liquid crystal device according to the above aspect of the invention, the integrated circuit device including: a driver capable of driving the scanning lines, the data lines, and the opposing electrodes; and a control unit configured to supply a control signal and an image signal for the display or the light modulation.

According to the configuration of the aspect of the invention, a low-cost IC for driving an OCB-mode liquid crystal device is implemented which has a simple circuit configuration and does not require any special high-voltage device.

### Aspect 20

According to a twentieth aspect of the invention, there is provided an electronic apparatus including the liquid crystal device according to any one of the aspects.

According to the configuration of the aspect of the invention, the liquid crystal device according to only one of the aspects has a simple configuration and can realize the initial sequence of the OCB-mode liquid crystals in a satisfactory manner. Therefore, the electronic apparatus having mounted thereon the liquid crystal device according to any one of the aspects can provide an advantage such as small size and low cost.

### BRIEF DESCRIPTION OF THE DRAWINGS

The invention will be described with reference to the accompanying drawings, wherein like numbers reference like elements.

FIG. 1 is a diagram illustrating an outline of a sequence from the power-on to the pixel display in an OCB-mode liquid crystal device.

FIGS. 2A to 2D are diagrams illustrating an alignment state of liquid crystal molecules in an initial sequence in an OCB-mode liquid crystal device according to an embodiment of the present invention.

FIG. 3 is a diagram for explaining an outline of an initial sequence in an OCB-mode liquid crystal device according to an embodiment of the present invention.

FIG. 4 is a diagram illustrating a configuration example of a liquid crystal device according to an embodiment of the present invention.

FIG. 5 is a diagram illustrating a configuration example of a liquid crystal driving IC.

FIG. 6 is a diagram illustrating a configuration example of a pixel unit of a liquid crystal device according to an embodiment of the present invention.

FIG. 7 is a diagram illustrating an exemplary cross-sectional structure of a device in the vicinity of a scanning line and a pixel electrode disposed mutually adjacent to each other.

FIG. 8 is a diagram for explaining a specific example of a driving method in a bend transition nucleus generation sequence.

FIG. 9 is a timing diagram for explaining a driving method for implementing the driving method illustrated in FIG. 8.

FIGS. 10A and 10B are diagrams illustrating the application aspects of horizontal and vertical electric fields to a pixel circuit during execution of the bend transition nucleus generation sequence illustrated in FIGS. 8 and 9.

FIG. 11 is a timing diagram for explaining an example of a driving method for implementing Example 2 of bend transition nucleus generation sequence.

FIGS. 12A and 12B are diagrams illustrating the application aspects of horizontal and vertical electric fields to a pixel circuit according to Example 2 of bend transition nucleus generation sequence illustrated in FIG. 11.

FIGS. 13A and 13B are diagrams illustrating another exemplary driving method (multiline sequential driving and field sequential driving) during bend transition nucleus generation.

FIG. 14 is a diagram illustrating a specific example of a driving method for bend transition expansion using a vertical electric field.

FIG. 15 is a timing diagram for explaining a driving method for implementing the driving method illustrated in FIG. 14.

FIGS. 16A and 16B are diagrams illustrating the application aspects of electric fields to a pixel circuit during execution of the bend transition expansion sequence illustrated in FIG. 15.

FIGS. 17A and 17B are top and cross-sectional views, respectively, of an OCB-mode liquid crystal device according to an embodiment of the present invention.

FIG. 18 is a diagram illustrating another example of the layout of a pixel unit to allow efficient generation of a horizontal electric field.

FIG. 19 is a diagram illustrating a further example of the layout of a pixel unit to allow efficient generation of a horizontal electric field.

FIGS. 20A and 20B are partially cutaway views of the pixel unit illustrated in FIG. 19.

FIG. 21 is a perspective view illustrating an overall configuration of a mobile phone having mounted thereon the liquid crystal device of the present invention.

FIG. 22 is a perspective view of an information device having mounted thereon the liquid crystal device of the present invention.

### DESCRIPTION OF EXEMPLARY EMBODIMENTS

### Embodiment 1

An embodiment of the invention will be described in detail. It should be noted that the embodiment described below do not restrict disadvantageously the content of the present invention recited in the scope of the Claims and not all of the constructions described with reference to the following embodiments are necessary as solving means of the present invention.

A liquid crystal device according to a first embodiment of the present invention will be described. The present embodiment will be described by way of an example of a TFT active matrix type OCB-mode liquid crystal device in which thin film transistors (hereinafter referred to as TFTs) are used as switching elements.

### Outline of Initial Sequence of OCB-mode Liquid Crystal Device

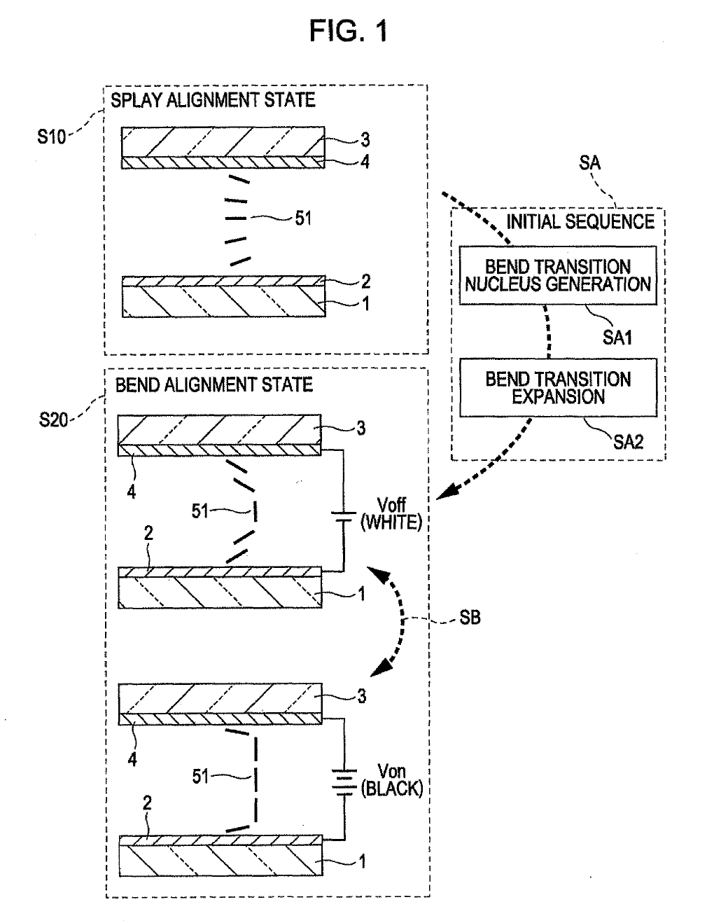

First, an outline of the operation of an OCB-mode liquid crystal device will be described. FIG. 1 is a diagram illustrating an outline of a sequence from the power-on to the pixel display in an OCB-mode liquid crystal device.

As illustrated in the drawing, during a power-on state, liquid crystal molecules 51 that constitute a liquid crystal layer disposed between an alignment film 2 formed on an array substrate 1 and an alignment film 4 formed on an opposing substrate 3 are in a splay alignment state (state S10).

Then, an initial sequence SA is executed after the power-on operation is performed. Specifically, a bend transition nucleus generation sequence SA1 is first executed so that a bend transition nucleus is generated, and thereafter, a bend transition expansion sequence SA2 is executed so that the bend transition nucleus generated in the bend transition nucleus generation sequence SA1 is expanded. As a result, the entire liquid crystal molecules 51 of a liquid crystal device are in a bend alignment state (state S20), whereby images can be displayed (or light modulation can be performed in accordance with image data).

That is, an inter-electrode voltage is switched between Voff and Von, whereby images are displayed as white or black dots, for example.

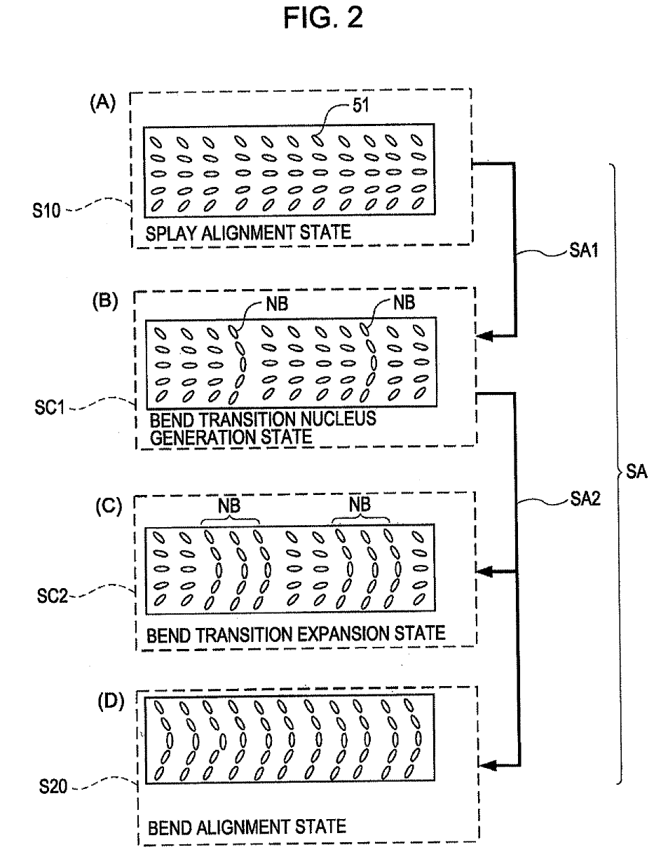

Next, a specific example of the initial sequence (SA) of the OCB-mode liquid crystal device according to the present invention will be described, FIGS. 2A to 2D are diagrams illustrating an alignment state of liquid crystal molecules in an initial sequence in an OCB-mode liquid crystal device according to an embodiment of the present invention.

in the OCB-mode liquid crystal device, during a power-on state, i.e., in an initial state, the liquid crystal molecules are in the splay alignment state as shown in FIG. 2A, and during a display operation, the liquid crystal molecules are in the bend alignment state as shown in FIG. 2D.

The procedures from the state of FIG. 2A to the state of FIG. 2D will be described. It should be noted that in the respective drawings, the alignment states of the liquid crystal molecules are simplified for better understanding of the transition progress to the bend alignment.

As illustrated in the drawing, the initial sequence SA includes the bend transition nucleus generation sequence SA1 by means of a horizontal electric field and the bend transition expansion sequence SA2 by means of a vertical electric field.

In the OCB-mode liquid crystal device, in a state in which voltages are not applied to pixel electrodes and opposing electrodes and between pixel electrodes and scanning lines, respectively, (or during non-selection voltage application), the liquid crystal molecules 51 are in the splay alignment state (state S10) as shown in FIG. 2A.

When power is activated, since the pixel electrodes and the scanning lines have different potential levels, a horizontal electric field is generated between the pixel electrodes and the scanning lines (including the selected ones and the non-selected ones of the scanning lines) opposite the pixel electrodes. At this time, it is desirable that the pixel electrodes and the opposing electrodes are at the same potential level so that a vertical electric field is not generated. However, the present invention is not limited to this.

As a result, as illustrated in FIG. 2B, a disclination line (a defective region where the alignment of the liquid crystal molecules is discontinuous) is generated by the horizontal electric field due to an alignment error. That is, some liquid crystal molecules NB of the liquid crystal molecules 51 function as a bend transition nucleus as shown in FIG. 2B, and thus the liquid crystal molecules are in a bend transition nucleus generation state (state SC1).

Next, a potential difference is applied between the pixel electrodes and the opposing electrodes, whereby a vertical electric field is generated between the pixel electrodes and the opposing electrodes. As a result, the liquid crystal molecules NB that are aligned by the effect of the horizontal electric field function as the bend transition nucleus, and the bend alignment is expanded to the peripheries of the liquid crystal molecules NB, whereby the liquid crystal molecules are in a bend transition expansion state (state SC2) as shown in FIG. 2C.

The bend transition expansion progresses over the entire liquid crystal molecules 51, whereby the liquid crystal molecules are in a bend alignment state (state S20) as shown in FIG. 2D.

In this way, according to the present embodiment, during the initial sequence SA, the bend transition nucleus is first generated by means of the horizontal electric field generated between the scanning lines and the pixel electrodes during voltage application (bend transition nucleus generation sequence SA1). Thereafter, the bend transition nucleus is expanded by means of the vertical electric field generated between the pixel electrodes and the opposing electrodes (bend transition expansion sequence SA2), so that an image display can be performed in a state that the entire image display regions are maintained in the bend alignment state.

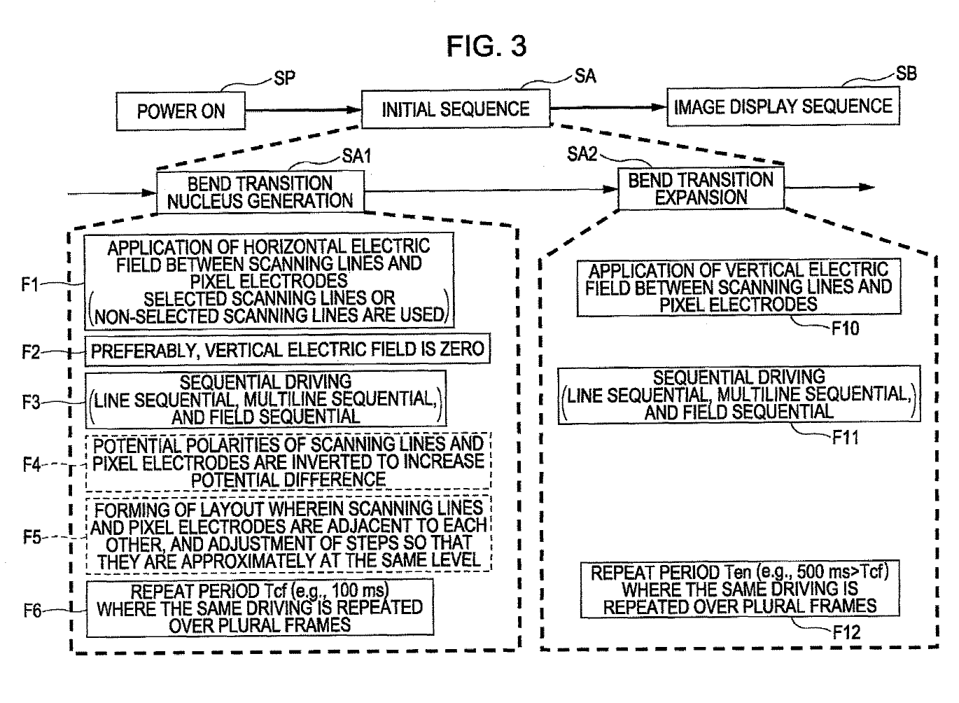

Next, an outline of an initial sequence of the OCB-mode liquid crystal device according to the present invention will be described. FIG. 3 is a diagram for explaining an outline of an initial sequence in an OCB-mode liquid crystal device according to an embodiment of the present invention. First, power is activated (step SP), whereby the initial sequence SA of the OCB-mode liquid crystal device of the present invention is executed.

The initial sequence SA includes the bend transition nucleus generation sequence SA1 and the bend transition expansion sequence SA2.

In the bend transition nucleus generation sequence SA1, a horizontal electric field is generated between the scanning lines and the pixel electrodes (F1). In this case, both the non-selected ones and the selected ones of the scanning lines can be used. In particular, when aggressively using a horizontal electric field generated by a potential difference between the pixel electrodes and the non-selected ones of the scanning lines, it is possible to apply a strong horizontal electric field to the liquid crystals for a longer period in a satisfactory manner.

Moreover, when the horizontal electric field is generated using both the non-selected ones and the selected ones of the scanning lines, the horizontal electric field can be continuously applied to the liquid crystals, and thus the bend transition nucleus generation can be realized in an efficient manner.

When generating the horizontal electric field, it is preferable that a vertical electric field is not generated between the pixel electrodes and the opposing electrodes (F2). In general, it is necessary to generate a localized strong horizontal electric field by applying a potential difference between the scanning lines and the pixel electrodes in order to realize the bend transition nucleus generation. However, in this case, when an extra vertical electric field is generated, the amount of energy usable for generation of the horizontal electric field decreases. Moreover, there is a possibility that the vertical electric field may have any adverse effect on the bend transition nucleus generation.

Therefore, it is desirable to set the vertical electric field to zero and to generate a localized electric field as strong as possible during the bend transition nucleus generation by means of the horizontal electric field.

However, the present invention is not limited to this. For example, in practical implementations, a slight vertical electric field may be generated due to some driving reasons. Moreover, when the scanning lines and the pixel electrodes are not parallel to each other due to presence of a step difference of a device, a vertical electric field component is inevitably generated when a potential difference is applied between the scanning lines and the pixel electrodes. In order to remove such a vertical electric field component, a method may be considered in which a vertical electric field is intentionally generated in a reverse direction. Such a method is also included in the technical scope of the present invention. Even when the vertical electric field is generated simultaneously with the horizontal electric field, the localized horizontal electric field is dominant, and in no cases, the vertical electric field is greater than the horizontal electric field.

Preferably, sequential driving is employed as a data writing method (F3). Examples of the sequential driving include a line sequential driving method, a multiline sequential driving method, and a field sequential driving method,

The line sequential driving method is a driving method in which image data are sequentially written to pixel circuits that are connected to a single scanning line,

The multiline sequential driving method is a driving method in which multiple lines of the scanning lines are simultaneously activated, and image data are simultaneously written to pixel circuits that are connected to the multiple activated lines of the scanning lines so that such operations are sequentially performed. By using a method that simultaneously drives n lines of the scanning lines, the image data writing speed can be increased by n times. Therefore, when it is assumed that one frame period is fixed, it is possible to provide an advantage that the time in which a voltage is applied to the respective pixels can be increased by n times.

The field sequential driving method is a driving method in which the entire scanning lines are simultaneously activated and image data are written in a collective manner. Although such a driving method is not a typical one, for example, when the field sequential driving can be used for the purpose of inspection of a liquid crystal device, the field sequential driving may be employed in the initial sequence.

When generating the horizontal electric field between the scanning lines and the pixel electrodes, it is preferable to increase a potential difference between the scanning lines and the pixel electrodes by applying voltages of opposite polarities to the scanning lines and the pixel electrodes, respectively (F4). For example, a first voltage of a positive polarity is applied to the pixel electrodes, and a second voltage of a negative polarity is applied to the scanning lines. Even though the first and second voltages do not have large absolute values, because their potentials are of opposite polarities, the potential difference corresponds to the sum of the absolute values of the first and second voltages. Accordingly, a strong horizontal electric field required for the bend transition nucleus generation can be generated in a satisfactory manner without needing to generate an excessively high voltage.

Moreover, preferably, during the operations described above, the same driving method is performed repeatedly over a plurality of frame periods (F6). In this case, a repetition period Tcf is set to 100 ms, for example.

It is preferable to form a layout wherein the scanning lines and the pixel electrodes are disposed mutually adjacent to each other and to adjust step differences so that they are approximately at the same level in cross-sectional structure (F5). By doing this, a strong horizontal electric field can be easily generated.

Next, the bend transition expansion sequence SA2 is executed. With this sequence, the bend transition nucleus generated in the bend transition nucleus generation sequence SA1 can be quickly expanded to the peripheries.

In the bend transition expansion sequence SA2, a potential difference is first applied between the pixel electrodes and the opposing electrodes so that a vertical electric field is generated between the pixel electrodes and the opposing electrodes (F10). Thereafter, preferably, sequential driving is performed (F11).

In this case, data writing may be performed by an arbitrary sequential driving method selected from a line sequential driving method, a multiline sequential driving method, and a field sequential driving method. Preferably, the same driving method is performed repeatedly over a plurality of frame periods (F12). In this case, a repetition period Ten is set to 500 ms, for example, so as to be longer than the repetition period Tcf during the operation F6 in the bend transition nucleus generation sequence SA1.

By the operations described above, the bend transition expansion sequence SA2 is executed to facilitate the expansion of the bend transition nucleus generated in the bend transition nucleus generation sequence SA1, and thereafter, the procedure proceeds to an image display sequence SB.

### Configuration Example of Liquid Crystal Device

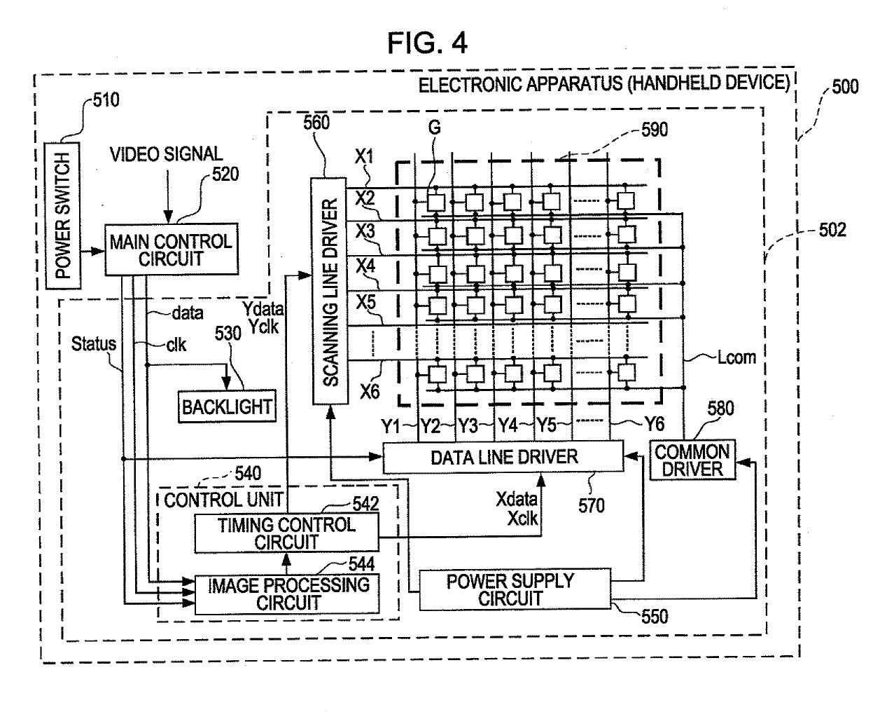

FIG. 4 is a diagram illustrating a configuration example of a liquid crystal device according to the embodiment of the present invention. As shown in the drawing, an OCB-mode liquid crystal device 502 is mounted on an electronic apparatus (e.g., a handheld device) 500.

The liquid crystal device 502 includes a backlight 530, a control unit 540, a power supply circuit 550, a scanning line driver 560, a data line driver 570, a common driver 580, and a pixel array (image display portion) 590. The pixel array 590 includes a plurality of pixels G that are arranged in matrix. The pixels G are selected by corresponding ones of scanning lines X1 to X6 and corresponding ones of data lines Y1 to Y6.

The scanning line driver 560 drives the respective scanning lines X1 to X6. As a driving method of the scanning lines, a line sequential driving method can be employed, and besides, a multiline sequential driving method or a field sequential driving method may be employed. The data line driver 570 drives the respective data lines Y1 to Y6. The common driver 580 changes a potential of a common line Lcom in a periodical manner. The power supply circuit 550 supplied source voltages (various voltages) to the scanning line driver 560, the data line driver 570, and the common driver 580, respectively.

The control unit 540 controls the overall operation of the liquid crystal device. The control unit 540 includes a timing control circuit 542 and an image processing circuit 544.

A power switch 510 mounted on the electronic apparatus is a switch that turns on and off the electronic apparatus 500. A main control circuit 520 mounted on the electronic apparatus is configured to receive a video signal and an output from the power switch 510 and supply the image processing circuit 544 with a clock signal “clk,” an image data signal “data,” and a status signal “status” that carries information as to status such as power-on or power-off. The status signal “status” is also supplied to the data line driver 570. Therefore, the data line driver 570 can recognize the status of the power switch 510.

The image processing circuit 544 performs image processing on the input image data. The timing control circuit 542 outputs a Y data signal “Ydata,” a Y clock signal “Yclk,” an X data signal “Xdata,” and an X clock signal “Xclk.”

When power is activated, the power supply circuit 550 is turned on, and thus the scanning line driver 560, the data line driver 570, and the common driver 580 are turned on, whereby predetermined voltages are supplied to respective blocks. In this way, the initial sequence SA is executed. Thereafter, the image display sequence SB is executed, whereby images are displayed on the pixel array (image display portion) 590.

### Configuration Example of Liquid Crystal Driving IC

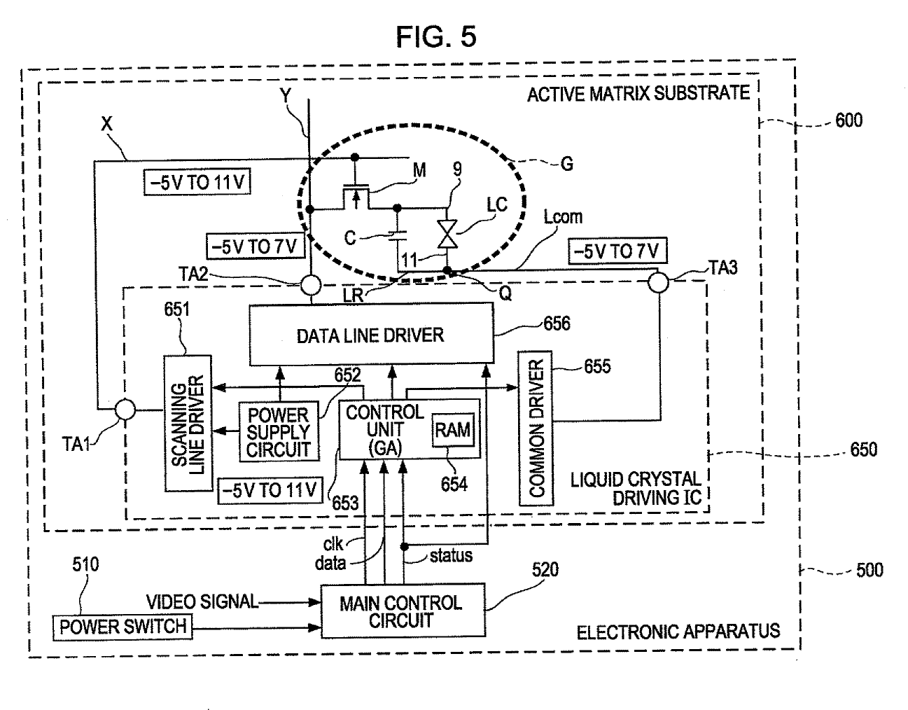

FIG. 5 is a diagram illustrating a configuration example of a liquid crystal driving IC. A liquid crystal driving IC 650 is integrated into the liquid crystal device 502 shown in FIG. 4. The liquid crystal driving IC 650 includes a power supply circuit 652, a RAM 654 as an information storage memory, a control unit 653 that receives a signal from the main control circuit 520, a scanning line driver 651, a data line driver 656, and a common driver 655.

The control unit 653 is a gate array GA that is configured to supply image data to the data line driver 656 and control signals to the respective drivers 651, 656, and 655, thereby controlling the operations of the drivers.

### Operating Voltage of Liquid Crystal Driving IC

As illustrated in FIG. 5, the voltage supplied to the scanning lines is in the range of about −5 V to about 11 V; the voltage supplied to the data lines is in the range of about −5 V to about 7 V; and the voltage supplied to the common line is in the range of about −5 V to about 7 V. That is, the liquid crystal driving IC only needs to be capable of operating at a voltage as high as about 11 V, and thus application of an excessively high voltage is not necessary. Therefore, the driving device can be easily manufactured in an IC form, and the liquid crystal driving IC can be advantageously manufactured at low cost.

### Exemplary Pixel Configuration for Implementing Bend Transition Nucleus Generation by Means of Horizontal Electric Field

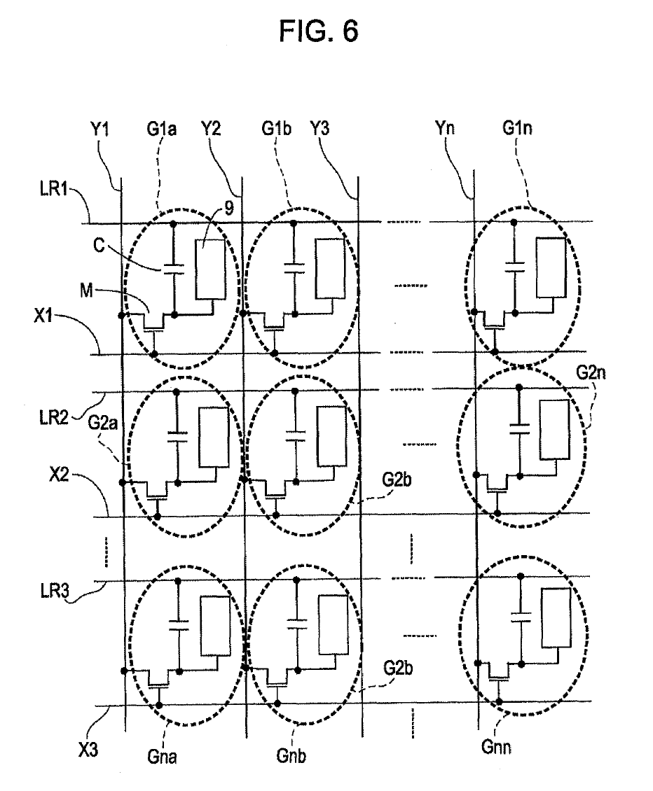

FIG. 6 is a diagram illustrating a configuration example of a pixel unit of a liquid crystal device according to an embodiment of the present invention. As shown in the drawing, pixel electrodes 9 are formed in the plurality of pixels that are arranged in matrix. At one sides of the pixel electrodes 9, TFT elements M as switching elements that control conduction of the pixel electrodes 9 are formed. The sources of the TFT elements M are electrically connected to data lines Y1 to Yn. The data lines Y1 to Yn are supplied with image signals. The image signals may be supplied to the respective data lines Y1 to Yn in a line sequential manner and may be supplied to each group of the data lines Y1 to Yn that are mutually adjacent to each other.

The gates of the TFT elements N are electrically connected to scanning lines X1 to X3. The scanning lines X1 to X3 are supplied with scanning pulse signals at a predetermined timing. The scanning signals are sequentially supplied to the respective scanning lines X1 to X3. The drains of the TFT elements M are electrically connected to the pixel electrodes 9. A plurality of pixel circuits (G1a to G1n, G2a to G2n, and Gna to Gnn) is configured by the TFT elements M, sustain capacitors C, and the pixel electrodes 9. When the TFT elements M as the switching elements are turned on for only a predetermined period by the scanning signals supplied from the scanning lines X1 to X3, the image signals supplied from the data lines Y1 to Yn are written to the liquid crystals of the respective pixels at a predetermined timing.

The image signals written to the liquid crystals, having a predetermined level are maintained for a predetermined period by liquid crystal capacitors formed between the pixel electrodes 9 and later-described opposing electrodes. Moreover, in order to prevent leaking of the sustained image signals, sustain capacitors C are formed between the pixel electrodes 9 and capacitive lines LR1 to LR3 and connected in parallel to the liquid crystal capacitors. When a voltage is applied to the liquid crystals, the bend alignment state of the liquid crystal molecules is changed in accordance with the voltage level. In this way, light incident on the liquid crystals is modulated, whereby a gradation display is carried out.

Even when voltage application for the Initial sequence SA is performed, in a manner similar to the case of the image display operation, initial sequence signals are applied to the data lines, and the scanning signals are supplied to the scanning lines, whereby a plurality of pixels within a display region are driven.

The strong horizontal electric field for realizing the bend transition nucleus generation during the initial sequence can be generated by arranging the scanning lines and the pixel electrodes so as to be mutually adjacent to each other. An exemplary device structure in which the scanning lines and the pixel electrodes are disposed at close proximity will be described.

### Exemplary Cross-sectional Structure in the Vicinity of Mutually Adjacent Scanning Lines and Pixel Electrodes

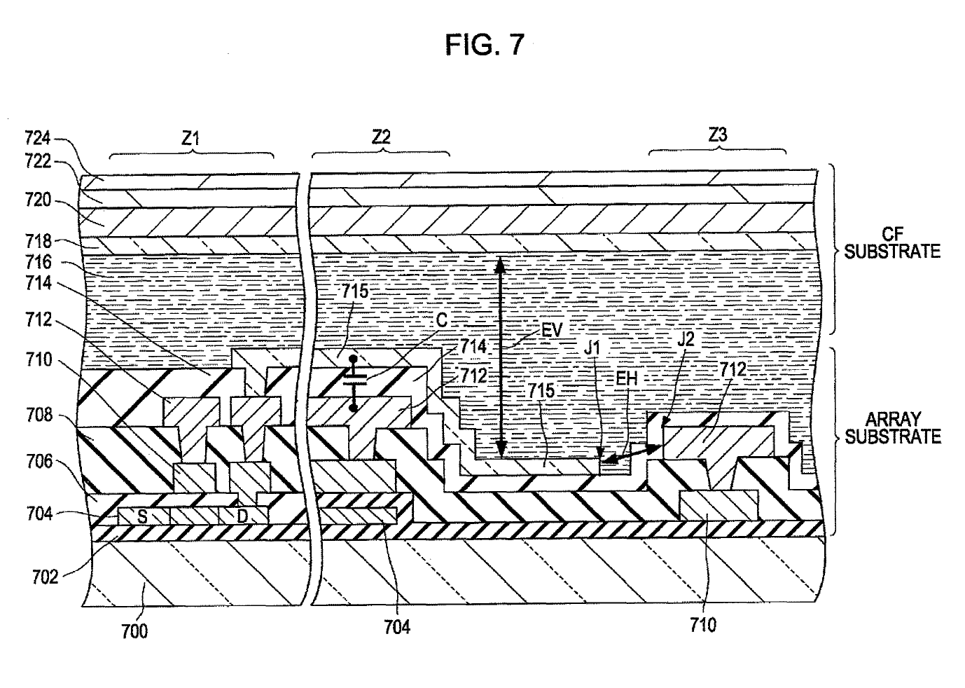

FIG. 7 is a diagram illustrating an exemplary cross-sectional structure of a device in the vicinity of a scanning line and a pixel electrode disposed mutually adjacent to each other. Referring to FIG. 7, a TFT region Z1 is a region in which a pixel transistor are formed, a sustain capacitor region Z2 is a region in which the sustain capacitor C is formed, and a scanning line region Z3 is a region in which a scanning line X1 is formed.

The liquid crystal device illustrated in FIG. 7 is configured by an array substrate, a color filter substrate (CF substrate), and OCB-mode liquid crystals 716 that are filled between the substrates.

The array substrate includes an insulating film 702 formed on a glass substrate 700, a conductive film (source/drain region) 704 formed of polysilicon or the like, an insulating film 706, a first metal wiring layer 710, an interlayer insulating film 708, a second metal wiring layer (scanning line) 712, an interlayer insulating film 714, and a pixel electrode 715 formed from transparent conductive materials such as ITO (indiumtin oxides).

The color filter substrate (CF substrate) includes an ITO film 718, an overcoat layer 720, a color filter layer 722, and a black matrix layer 724,

Here, attention is paid to a region between the sustain capacitor region Z2 and the scanning line region Z3. As illustrated in the drawing, the pixel electrode 715 and the second metal wiring layer 712 in the scanning line region Z3 are arranged such that the mutual distance is decreased as much as possible at approximately the same height position.

Therefore, a strong horizontal electric field EH for realizing the bend transition nucleus generation can be generated in an efficient manner between an end portion J1 of the pixel electrode 715 and an end portion J2 of the second metal wiring layer 712. Moreover, when a potential difference is applied between the pixel electrode 715 and the ITO film (opposing electrode) 718, it is possible to generate a vertical electric field EV necessary for the bend transition nucleus expansion.

### Specific Example of Driving Method for Bend Transition Nucleus Generation by Means of Horizontal Electric Field

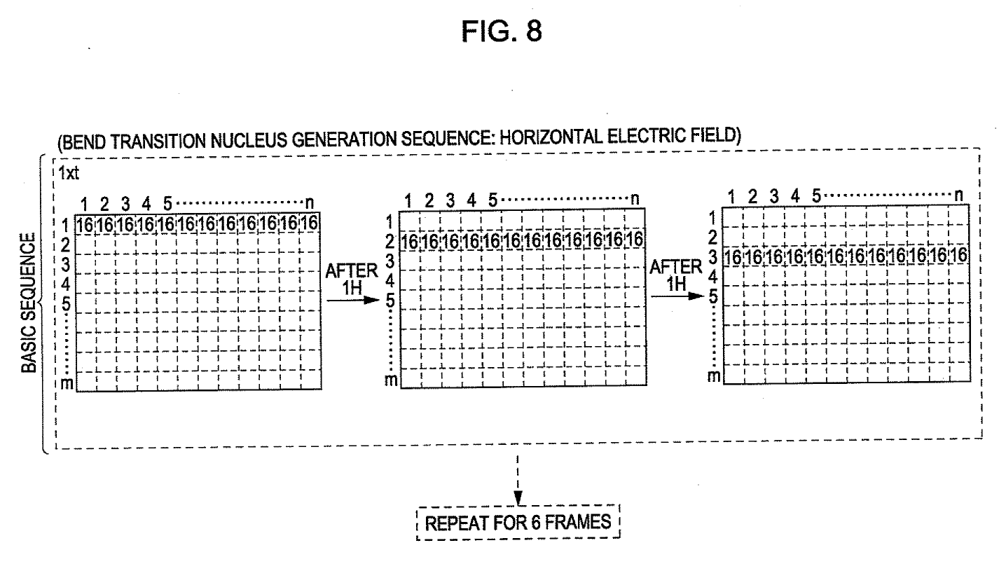

A specific example of the driving method for realizing the bend transition nucleus generation by means of a horizontal electric field will be described with reference to FIGS. 8 to 13.

FIG. 8 is a diagram for explaining a specific example of a driving method in a bend transition nucleus generation sequence. In this example, a case will be considered in which pixels are arranged in a matrix having m rows and n columns and driven in a line sequential manner. In the drawing, a number filled in each pixel designates a potential difference between a scanning line and a pixel electrode.

As illustrated in the drawing, a horizontal electric field of 16 V is first applied to a pixel array of the first row. Similar operations are performed on pixel arrays of each row. One frame period ends when application of the horizontal electric field to the pixel array of the m-th row is completed.

Subsequently, the same operation is repeated for six frame periods in total (100 ms assuming one frame period be 1/60 seconds).

In this way, a horizontal electric field of a predetermined voltage is applied to the respective pixels for a predetermined period or more, whereby disclination (a bend transition nucleus) is generated in a reliable manner.

### Bend Transition Nucleus Generation Sequence Example 1

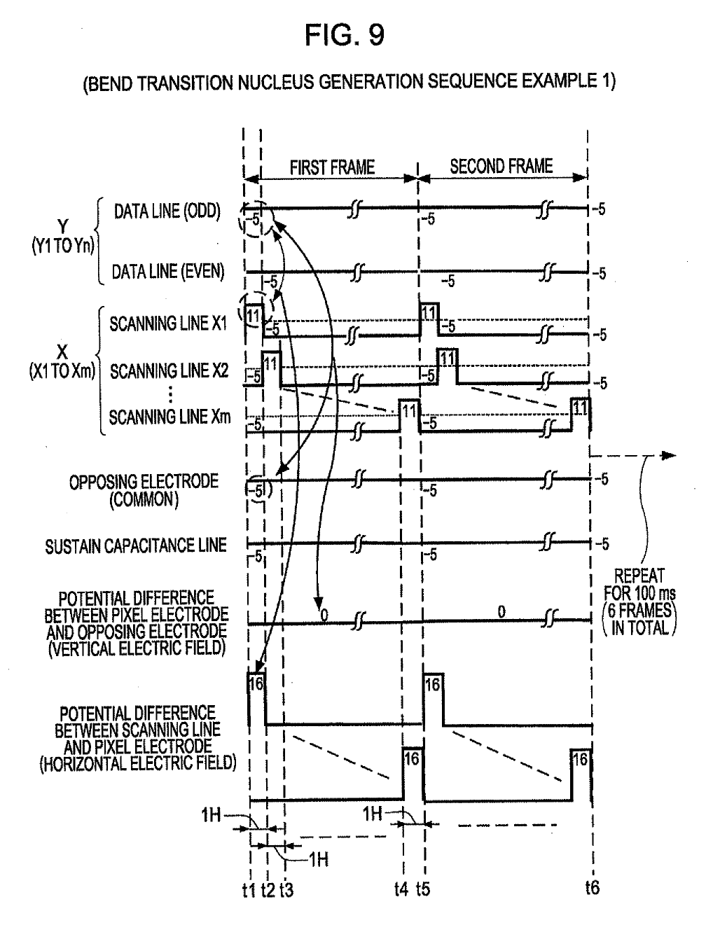

FIG. 9 is a timing diagram for explaining Example 1 of the bend transition nucleus generation sequence. In Example 1 of the bend transition nucleus generation sequence, a horizontal electric field for the bend transition nucleus generation is generated by means of a potential difference between the pixel electrodes and selected (activated) ones of the scanning lines. This will be described in detail below.

In a writing period (time t1 to t5) of one frame period, voltages of −5 V are applied to odd-numbered ones and even-numbered ones of the data lines Y1 to Yn, respectively, and at the same time, voltages of −5 V are similarly applied to the opposing electrode and the sustain capacitance line.

A scanning line X1 is selected at time t1 when the first one horizontal blanking period 1H starts, and a voltage of 11 V is applied to the scanning line X1, whereby a potential difference of 16 V (=11 V+5 V) is generated between the scanning line and the pixel electrode. Since voltages of opposite polarities are applied to the scanning line and the pixel electrode, respectively, even though the absolute values are small, a potential difference corresponding to the sum of the absolute values of both voltages is generated, whereby a strong horizontal electric field can be generated in a satisfactory manner.

In order for a scanning line X2 to be selected at time t2 when a subsequent one horizontal blanking period 1H starts, a voltage of −5 V is applied to the scanning line X1 and a voltage of 11 V is applied to the scanning line X2. A similar operation is repeated to select a scanning line Xm in the m-th horizontal blanking period, and a voltage of 11 V is applied to the scanning line Xm, whereby a first sequence of voltage applications is completed for the entire scanning lines.

At this time, since the data lines Y1 to Yn have a potential of −5 V and the opposing electrode has a potential of −5 V, a potential difference between the pixel electrode and the opposing electrode is zero; therefore, a vertical electric field is not generated. Therefore, a strong horizontal electric field can be applied to the liquid crystal layer (OCB-mode liquid crystals), and thus the bend transition nucleus can be generated in a reliable manner.

The blanking period continues between time t5 to time t6. One frame periods ends at time t6. Such a series of operations are performed repeatedly for six frame periods (100 ms), whereby the bend transition nucleus generation sequence is completed.

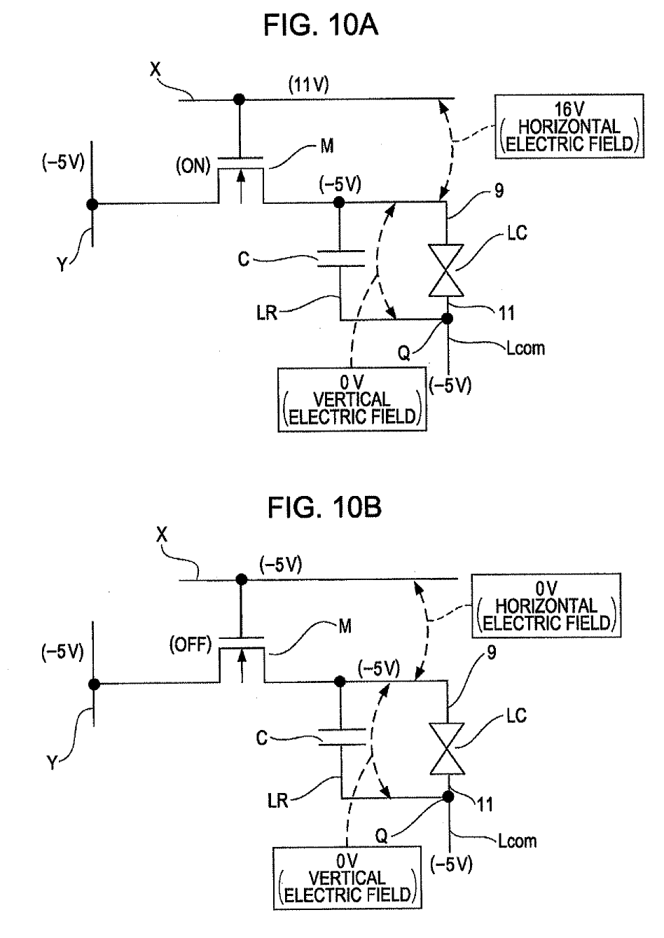

The application aspects of the horizontal and vertical electric fields to the pixel circuit according to Example 1 of the bend transition nucleus generation sequence are illustrated in FIGS. 10A and 10B. FIGS. 10A and 10B are diagrams illustrating the application aspects of horizontal and vertical electric fields to a pixel circuit according to Example 1 of the bend transition nucleus generation sequence illustrated in FIG. 9.

Referring to FIGS. 10A and 10B, a pixel circuit includes an N-type TFT switching element M having the gate connected to a scanning line X, the source connected to a data line Y, and the drain connected to a sustain capacitor C and a pixel electrode 9, and an liquid crystal LC connected in parallel to the sustain capacitor C.

FIG. 10B illustrates electric fields when the TFT switching element M is in an off state. That is, in FIG. 10B, the scanning line X has a potential of −5 V, and the data line Y has a potential of −5 V, whereby the TFT switching element N is turned off. Moreover, the common line Lcom has a potential of −5 V. Therefore, both the horizontal and vertical electric fields are zero.

Next, as illustrated in FIG. 10A, during the initial sequence, when the scanning line X is selected at the start of a writing period in the bend transition nucleus generation sequence, a voltage of 11 V is applied to the scanning line X, and at the same time, a voltage of −5 V is applied to the data line Y. Then, the TFT switching element M is turned on, and the drain of the TFT switching element N (i.e., the pixel electrode 9) has a potential of −5 V, whereby a horizontal electric field of 16 V(=11 V+5 V) is generated between the scanning line X and the pixel electrode 9.

At this time, since the pixel electrode 9 has a potential of −5 V and the common line Lcom has a potential of −5 V, no potential difference is applied between the pixel electrode 9 and the capacitive line LB; therefore, a vertical electric field between the pixel electrode 9 and the opposing electrode 11 is 0 V.

In this way, according to Example 1 of the bend transition nucleus generation sequence, it is possible to generate a strong electric field by means of a potential difference of 16 V in a satisfactory manner.

### Bend Transition Nucleus Generation Sequence Example 2

Example 2 of the bend transition nucleus generation sequence will be described. In Example 2 of the bend transition nucleus generation sequence, the horizontal electric field is generated using both non-selected (non-activated) ones and selected (activated) ones of the scanning lines. Since the non-selection period of the scanning lines is longer than the selection period, it is possible to increase the application time of the horizontal electric field to the OCB-mode liquid crystals by using Example 2 of the bend transition nucleus generation sequence. Therefore, it is possible to facilitate the generation of the bend transition nucleus. That is, the bend transition nucleus can be generated in an efficient manner.

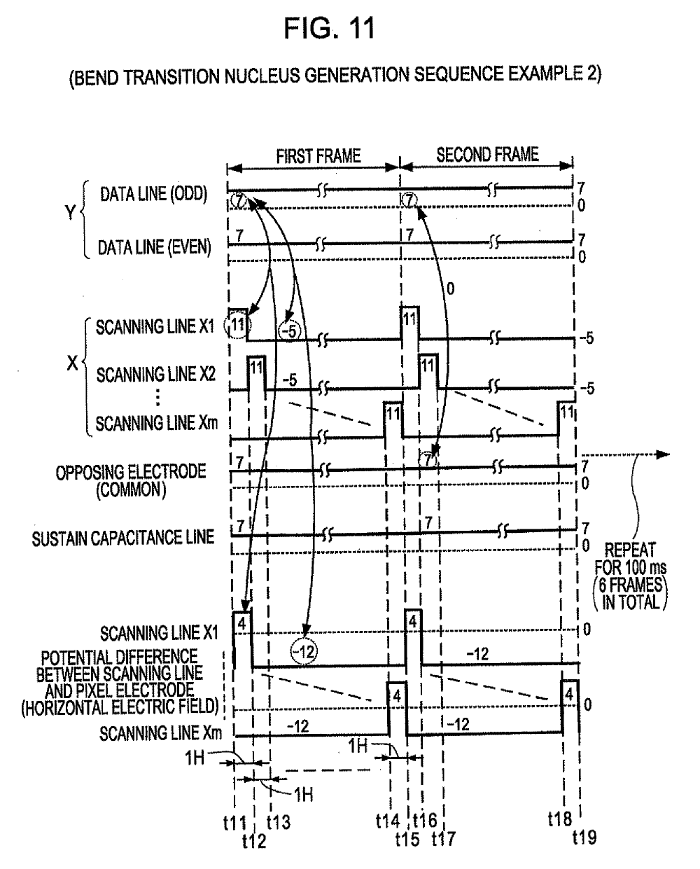

FIG. 11 is a timing diagram for explaining an example of a driving method for implementing Example 2 of the bend transition nucleus generation sequence. In a manner similar to Example 1 of the bend transition nucleus generation sequence, the scanning lines X are driven in a line sequential manner, whereby voltages (selection voltage) of 11 V are sequentially applied to the respective scanning lines every one horizontal blanking period. On the other hand, the non-selected ones of the scanning lines are maintained at a potential of −5 V.

The data lines Y, the opposing electrode 11 (common), and the capacitance line LR are maintained at a potential of 7 V.

Here, attention is paid to the scanning line X1 (the first scanning line). In a selection period (time t11 to t12) of the scanning line X1, a voltage of 11 V is applied to the scanning line X1, whereby the TFT switching element X is turned on, and the pixel electrode 9 has a voltage of 7 V. Therefore, a potential difference of 4 V is generated between the scanning line X1 and the pixel electrode 9, and a horizontal electric field is generated by this potential difference,

Next, attention is paid to a non-selection period (time t12 to t13) of the scanning line X1. In this case, the scanning line X1 has a voltage of −5 V, and thus the TET switching element M is turned off. However, the voltage of the pixel electrode 9 is maintained at 7 V by the sustain capacitor C. Therefore, a potential difference of −12 V is generated between the non-selected scanning line X1 and the pixel electrode 9, whereby a strong horizontal electric field can be generated. Such operations are similarly performed on other scanning lines X2 to Xm.

In this way, according to Example 2 of the bend transition nucleus generation sequence, during the non-selection period of the scanning lines X, a strong electric field can be continuously applied to the OCB-mode liquid crystals by means of a large potential difference of −12 V, for example. Therefore, it is possible to increase the total amount of energy applied to the OCB-mode liquid crystals, which contributes to the bend transition nucleus generation efficiency.

Moreover, even when the scanning lines X are selected, a horizontal electric field is applied to the OCB-mode liquid crystals by means of a potential difference of 4 V, for example. That is, the horizontal electric field can be always applied regardless of the selection or non-selection of the scanning lines X. Therefore, the bend transition nucleus generation can be performed in an efficient manner.

The operations corresponding to one frame period are performed repeatedly for six frame periods in total (100 ms). In this way, the bend transition nucleus can be generated in a reliable manner.

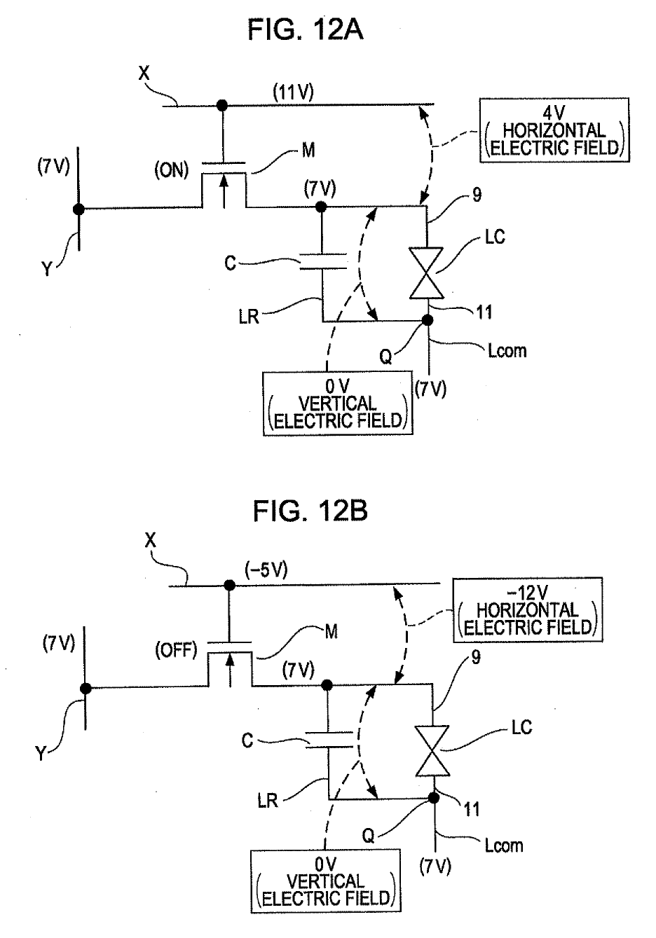

The application aspects of the horizontal and vertical electric fields to the pixel circuit according to Example 2 of the bend transition nucleus generation sequence are illustrated in FIGS. 12A and 12B.

FIGS. 12A and 12B are diagrams illustrating the application aspects of horizontal and vertical electric fields to a pixel circuit according to Example 2 of the bend transition nucleus generation sequence illustrated in FIG. 11.

As illustrated in FIG. 12A, during the initial sequence, when the scanning line X is selected at the start of a writing period in the bend transition nucleus generation sequence, a voltage of 11 V is applied to the scanning line X, and at the same time, a voltage of 7 V is applied to the data line Y. Then, the TFT switching element M is turned on, and the drain of the TFT switching element X (i.e., the pixel electrode 9) has a potential of 7 V, whereby a horizontal electric field of 4 V(=11 V−7 V) is generated between the scanning line X and the pixel electrode 9.

At this time, since the pixel electrode 9 has a potential of 7 V and the common line Lcom has a potential of 7 V, a potential difference between the pixel electrode 9 and the capacitive line LR is 0 V; therefore, a vertical electric field is not generated between the pixel electrode 9 and the opposing electrode 11.

FIG. 12B illustrates electric fields when the TFT switching element M is in an off state. That is, in FIG. 12B, the scanning line X has a potential of −5 V, and the data line Y has a potential of 7 V, whereby the TFT switching element M is turned off. However, since electric charges are stored in the sustain capacitor C, the potential of the pixel electrode 9 is maintained at 7 V.

Therefore, a potential difference of −12 V (=−5-7) is generated between the scanning line X and the pixel electrode 9, whereby a strong horizontal electric field is generated by means of the large potential difference, and this horizontal electric field is applied to the OCB-mode liquid crystals during the non-selection period of the scanning lines.

Moreover, the common line Lcom has a potential of 7 V. Therefore, a potential difference between the pixel electrode 9 and the opposing electrode 11 is 0 V, and thus the vertical electric field is not generated.

In this way, according to Example 2 of the bend transition nucleus generation sequence, the long non-selection period of the scanning lines can be effectively used; therefore, a strong horizontal electric field can be applied to the OCB-mode liquid crystals for a longer time. Moreover, since the horizontal electric field can be applied to the OCB-mode liquid crystals even during the selection period of the scanning lines, a localized horizontal electric field can be always (i.e., continuously) applied to the OCB-mode liquid crystals during the bend transition nucleus generation sequence. Therefore, the bend transition nucleus generation can be implemented in an excessively efficient manner. At this time, since the potential difference (−12 V in this example) during the non-selection period is larger than the potential difference (4 V in this example) during the selection period, a stronger horizontal electric field can be applied during the long non-selection period. Moreover, the strong horizontal electric field during the non-selection period can be generated by application of voltages of opposite polarities (in this example, −5 V and +7 V were applied to the scanning lines and the pixel electrodes, respectively) to the pixel electrodes and the non-selected ones of the scanning lines, respectively. Therefore, the strong horizontal electric field can be generated in a satisfactory manner.

Since the potential difference between the pixel electrodes and the opposing electrodes is zero during the bend transition nucleus generation, the horizontal electric field is not generated. As mentioned before, when an extra vertical electric field is generated, the amount of energy usable for generation of the horizontal electric field decreases. Moreover, there is a possibility that the vertical electric field may have any adverse effect on the bend transition nucleus generation. Therefore, it is desirable to set the vertical electric field to zero and to generate a localized electric field as strong as possible during the bend transition nucleus generation by means of the horizontal electric field. In the example described above, since the vertical electric field is not generated, a strong horizontal electric field can be applied to the liquid crystal layer (OCB-mode liquid crystals), and thus the bend transition nucleus can be generated in a reliable manner.

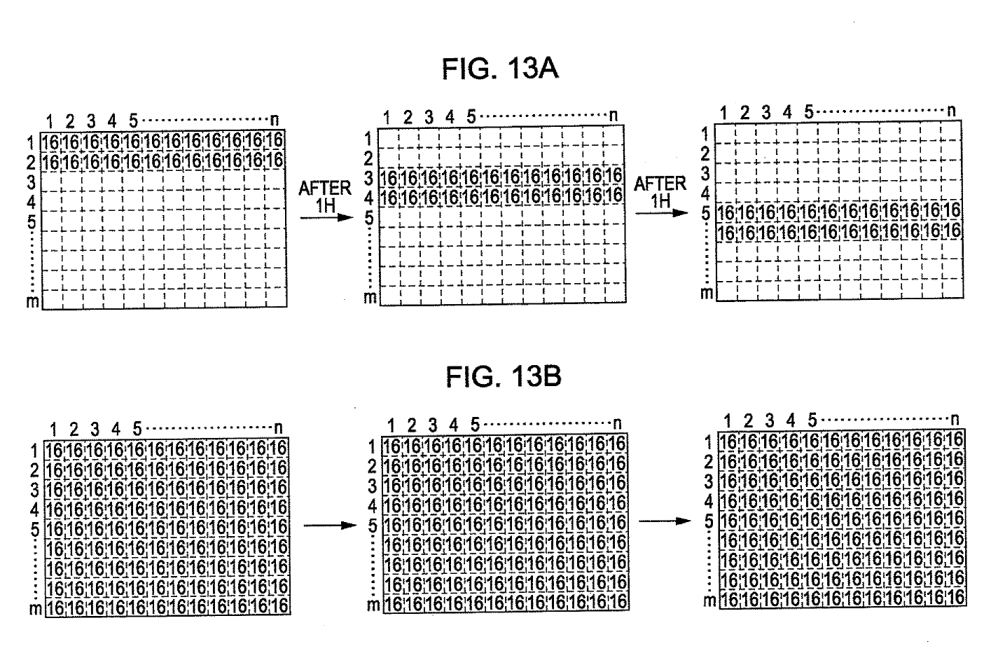

Although an example of the line sequential driving was described Hereinabove, as illustrated in FIG. 13A, a multiline sequential driving wherein m (where m=2) scanning lines are simultaneously driven may be employed. In the example illustrated in FIG. 13A, two lines are simultaneously driven. That is, when a multiline sequential driving can be used in a normal operation, the multiline sequential driving can be employed in the initial sequence. In such a case, it is possible to maintain consistency in the driving method during the normal operation and the initial sequence.

Moreover, as illustrated in FIG. 13B, a field sequential driving method wherein entire lines are driven may be employed. That is, when a field sequential driving can be used in a normal operation, the field sequential driving can be employed in the initial sequence. In such a case, it is possible to maintain consistency in the driving method during the normal operation and the initial sequence.

### Specific Example of Driving Method for Bend Transition Expansion Using Vertical Electric Field

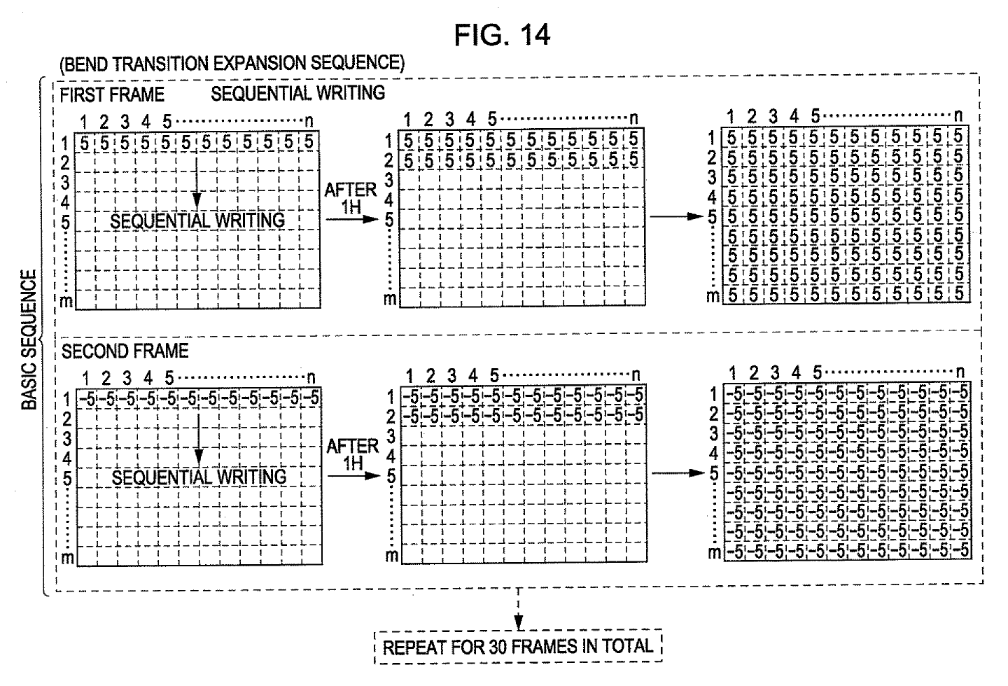

FIG. 14 is a diagram illustrating a specific example of a driving method for bend transition expansion using a vertical electric field. The bend transition expansion sequence requires two frames as a basic sequence. In this example, it is assumed that in the first and second frame periods, frame inversion driving is performed in order to invert polarities of voltages applied to liquid crystals (however, the present invention is not limited to this). Moreover, description will be made for a case where line sequential driving is employed as a driving method.

In the basic sequence (the first frame period) of FIG. 14, the scanning lines are sequentially selected on a one-by-one basis, whereby a voltage of 5 V, for example, is applied to the data lines so that a voltage of 5 V is applied to the pixel electrodes, and the opposing electrodes have 0 V. In this manner, a vertical electric field of +5 V is applied to the liquid crystals. In the case of normally white liquid crystals, this corresponds to simultaneously writing black data to the entire pixels.

Since the voltage of the pixel electrodes is maintained by the sustain capacitors even after the end of an activation period of one scanning line, the entire pixels will have a voltage of +5 V upon completion of data writing corresponding to one frame period, as illustrated in the upper right portion of FIG. 14.

Subsequently, in the basic sequence (the second frame period), the scanning lines are sequentially selected on a one-by-one basis, whereby a voltage of −5 V, for example, is applied to the data lines so that a voltage of −5 V is applied to the pixel electrodes, and the opposing electrodes have 0 V. In this manner, a vertical electric field of −5 V is applied to the liquid crystals. That is, although the potential difference between the pixel electrodes and the opposing electrodes is not changed from 5 V, the direction of the vertical electric field is inverted every frame period by the polarity inversion for each frame period.

Since the voltage of the pixel electrodes is maintained by the sustain capacitors even after the end of an activation period of one scanning line, the entire pixels will have a voltage of −5 V upon completion of data writing corresponding to one frame period, as illustrated in the lower right portion of FIG. 14.

Such a basic sequence that involves a series of two frame periods is repeated over 15 times. That is, a vertical electric field of 5 V is continuously applied to the liquid crystals for 30 frame periods in total. The application of the vertical electric field of 5 V is continued for 500 ms assuming one frame period be 1/60 seconds.

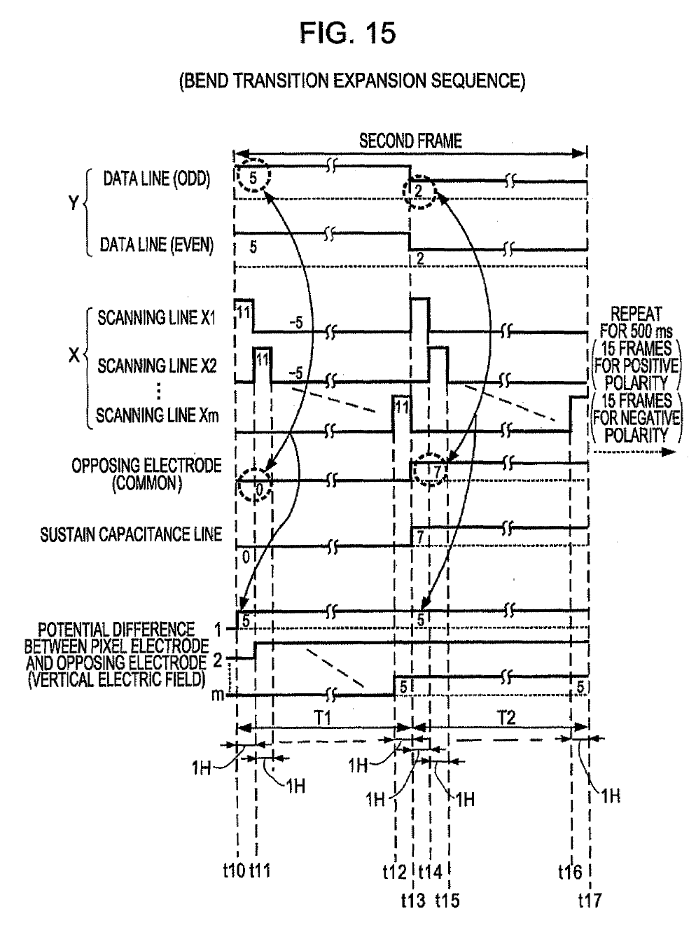

FIG. 15 is a timing diagram for explaining a driving method for implementing the driving method illustrated in FIG. 14.

During a first frame period T1 (time t10 to t13), a voltage of 5 V is applied to the data lines, and at the same time, the voltages of the opposing electrodes and the sustain capacitance line are 0 V.

The scanning lines are sequentially selected in a line sequential manner. A voltage of 11 V is applied to non-selected ones of the scanning lines, and a voltage of −5 V is applied to selected ones of the scanning lines. When the scanning lines are selected and the TETs are turned on, the data lines are applied with 5 V. Therefore, the pixel electrodes have a potential of +5 V, and a potential difference of +5 V is generated between the pixel electrodes and the opposing electrodes, whereby a vertical electric field of +5 V is applied to the liquid crystals.

During a second frame period T2 (time t13 to t17), a voltage of 2 V is applied to the data lines, and at the same time, a voltage of 7 V is applied to the opposing electrodes and the sustain capacitance line. Although the potential difference between the data lines and the opposing electrodes is 5 V similar to the first frame period, since the potential of the opposing electrodes is high in the second frame period, a vertical electric field of −5 V is applied to the liquid crystals (in a direction opposite to the direction of the vertical electric field generated by a potential difference of 5 V).

Such a series of operations are performed repeatedly for 15 positive-side frames and 15 negative-side frames (500 ms in total), whereby the bend transition expansion sequence is completed.

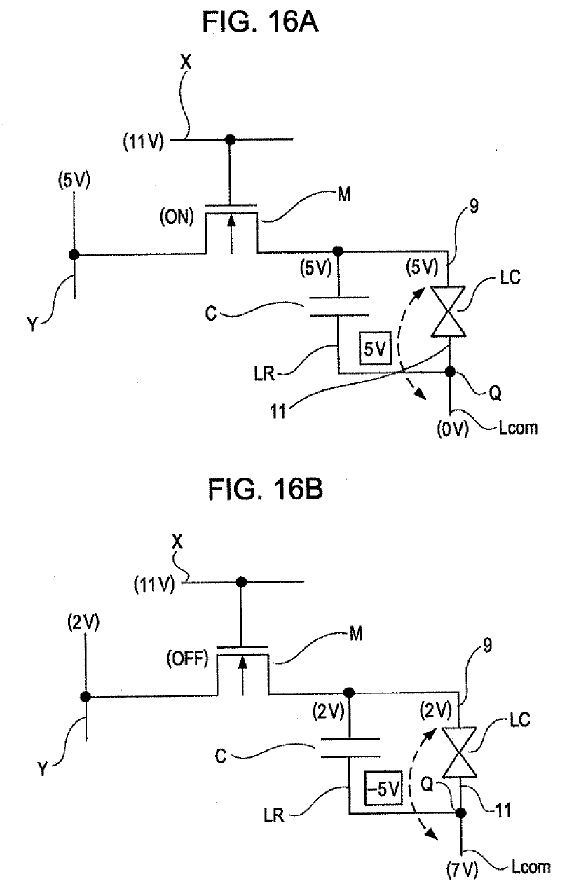

FIGS. 16A and 16B are diagrams illustrating the application aspects of electric fields to a pixel circuit during execution of the bend transition expansion sequence illustrated in FIGS. 14 and 15.

As illustrated in FIG. 16A, in the case of positive-polarity driving, the scanning line X has a potential of 11 V, the data line Y has a potential of 5 V, the pixel electrode 9 has a potential of 5 V, and the opposing electrode 11 (and the capacitive line LR) has a potential of 0 V. Therefore, a vertical electric field of 5 V is applied to the liquid crystal LC.

As illustrated in FIG. 16B, in the case of negative-polarity driving, the scanning line X has a potential of 11 V, the data line Y has a potential of 2 V, the pixel electrode 9 has a potential of 2 V, and the opposing electrode 11 (and the capacitive line LR) has a potential of 7 V. Therefore, a vertical electric field of −5 V is applied to the liquid crystal LC.

Since the scanning line has a potential of 11 V and the pixel electrode has a potential of 5 V or 2 V during the bend transition expansion sequence, a horizontal electric field is also generated. However, since the bend transition expansion sequence is mainly implemented by means of a strong vertical electric field, the horizontal electric field can be neglected in this case.

### Embodiment 2

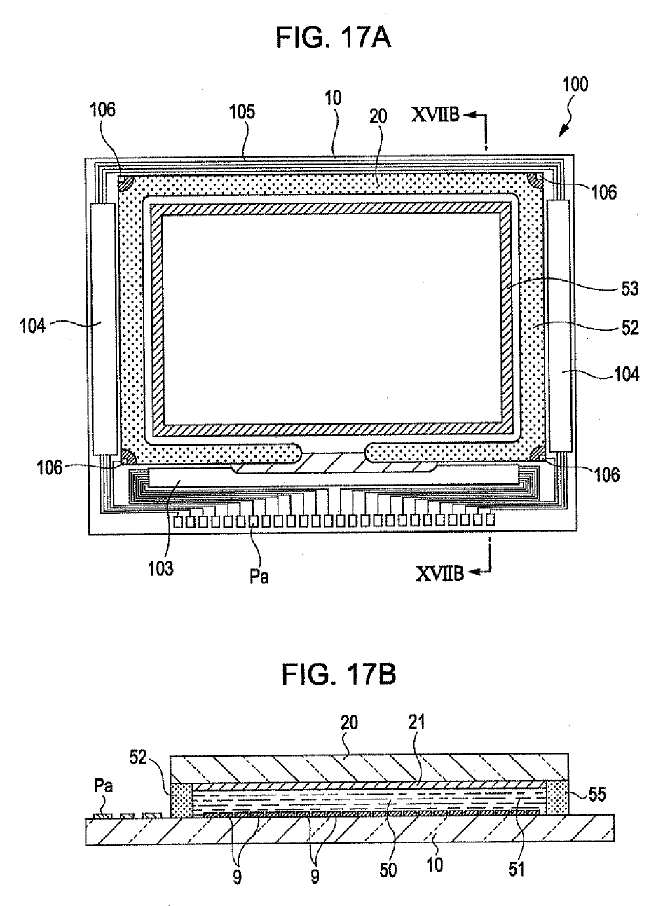

FIG. 17A is a top view of an OCB-mode liquid crystal device according to the present invention together with respective components, as viewed from the opposing substrate, and FIG. 17B is a cross-sectional view taken along the line XVIIB-XVIIB in FIG. 17A.

In the respective drawings, in order to recognize respective layers and respective members from the drawings, the respective layers and the respective members are illustrated with different scales.

As illustrated in FIGS. 17A and 17B, a liquid crystal device 100 according to the present invention includes a TFT array substrate 10 (a first substrate), an opposing substrate 20 (a second substrate) bonded to the array substrate 10 by means of a seal member 52, and a liquid crystal layer 50 filled in a region defined by the seal member 52. The liquid crystal layer 50 is constituted by liquid crystals having a positive dielectric anisotropy, and in an initial state, they are in a splay alignment state, while during a display operation, they are in a bend alignment state.

A light shielding film (periphery partition) 53 formed from materials having a light blocking effect is formed at an inner region of the seal member 52. On a peripheral circuit region outside the seal member 52, a data line driver 101 and an external circuit mounting terminal 102 are formed along one side of the array substrate 10, and scanning line drivers 104 are formed along two sides adjacent to the one side. On a remaining one side of the TFT array substrate 10, a plurality of wirings 105 are provided so as to be connected between the scanning line drivers 104 that are provided at opposite sides of the image display region.

At corner portions of the opposing substrate 20, inter-substrate conductive members 106 are arranged for electrical connection between the array substrate 10 and the opposing substrate 20. As illustrated in FIG. 17B, pixel electrodes 9 are formed at an inner side of the array substrate 10, and an opposing electrode 21 is formed in an inner side of the opposing substrate 20 disposed opposite the array substrate 10.

### Embodiment 3

A pixel layout that can generate a strong horizontal electric field is not limited to the layout illustrated in FIG. 6.

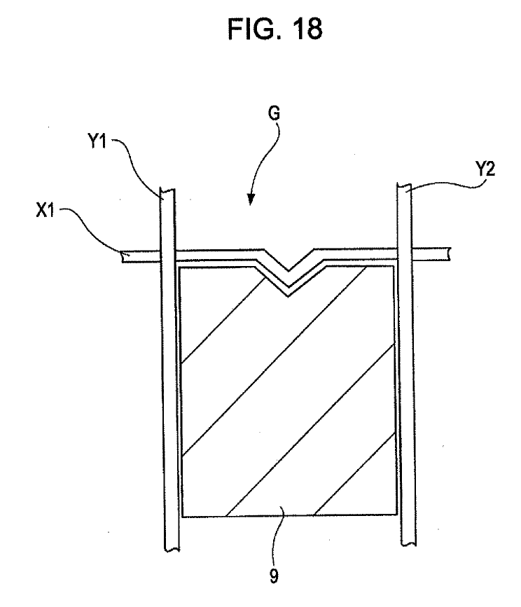

FIG. 18 is a diagram illustrating another example of the pixel layout to allow efficient generation of a horizontal electric field. Referring to FIG. 18, a concave portion is formed at an approximately central portion on an upper side of a pixel electrode 9 having an approximately square shape. A scanning line X1 is configured by a wiring disposed adjacent to this pixel electrode, which is deformed at the concave portion. As a result, deformed vertical electric field application portions for transition excitation are formed on the left, right, top and bottom of the pixel electrode.

Therefore, a high voltage is applied between upper and lower electrodes, whereby the liquid crystal layer is in the splay alignment state, and thus the distortion energy in the liquid crystal layer is increased higher than the surroundings. As a result, a horizontal electric field is perpendicularly applied from the horizontal electric field application portion in the alignment direction of the liquid crystal molecules. Therefore, the liquid crystal molecules on the lower substrate in the splay alignment state are applied with distortion force, and thus the bend transition nucleus can be easily generated.

### Embodiment 4

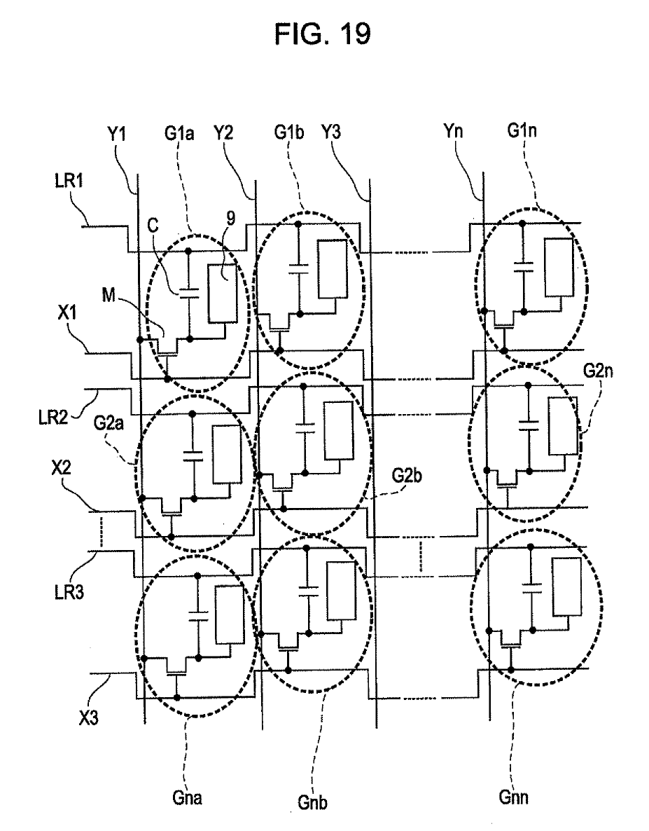

FIG. 19 is a diagram illustrating a further example of the pixel layout that can generate a strong horizontal electric field. In the example of FIG. 19, in order to generate a strong electric field between the scanning lines and the pixel electrodes in an efficient manner, a pixel layout is employed in which the pixel array is intentionally aligned in a non-linear fashion, and in which the scanning lines have bent portions.

As shown in the drawing, pixel electrodes 9 are formed in the plurality of pixels that are arranged in matrix. At one sides of the pixel electrodes 9, TFT elements X as switching elements that control conduction of the pixel electrodes 9 are formed. The sources of the TFT elements M are electrically connected to data lines Y1 to Yn. The data lines Y1 to Yn are supplied with image signals. The image signals may be supplied to the respective data lines Y1 to Yn in a line sequential manner and may be supplied to each group of the data lines Y1 to Yn that are mutually adjacent to each other.

The gates of the TFT elements M are electrically connected to scanning lines X1 to X3. The scanning lines X1 to X3 are supplied with scanning pulse signals at a predetermined timing. The scanning signals are sequentially supplied to the respective scanning lines X1 to X3. The drains of the TFT elements H are electrically connected to the pixel electrodes 9. A plurality of pixel circuits (G1a to G1n, G2a to G2n, and Gna to Gnn) is configured by the TFT elements M, sustain capacitors C, and the pixel electrodes 9. When the TFT elements H as the switching elements are turned on for only a predetermined period by the scanning signals supplied from the scanning lines X1 to X3, the image signals supplied from the data lines Y1 to Yn are written to the liquid crystals of the respective pixels at a predetermined timing.

The image signals written to the liquid crystals having a predetermined level are maintained for a predetermined period by liquid crystal capacitors formed between the pixel electrodes 9 and later-described opposing electrodes. Moreover, in order to prevent leaking of the sustained image signals, sustain capacitors C are formed between the pixel electrodes 9 and capacitive lines LR1 to LR3 and connected in parallel to the liquid crystal capacitors. When a voltage is applied to the liquid crystals, the bend alignment state of the liquid crystal molecules is changed in accordance with the voltage level. In this way, light incident on the liquid crystals is modulated, whereby a gradation display is carried out.

Even when voltage application for the Initial sequence SA is performed, in a manner similar to the case of the image display operation, initial sequence signals are applied to the data lines, and the scanning signals are supplied to the scanning lines, whereby a plurality of pixels within a display region are driven.

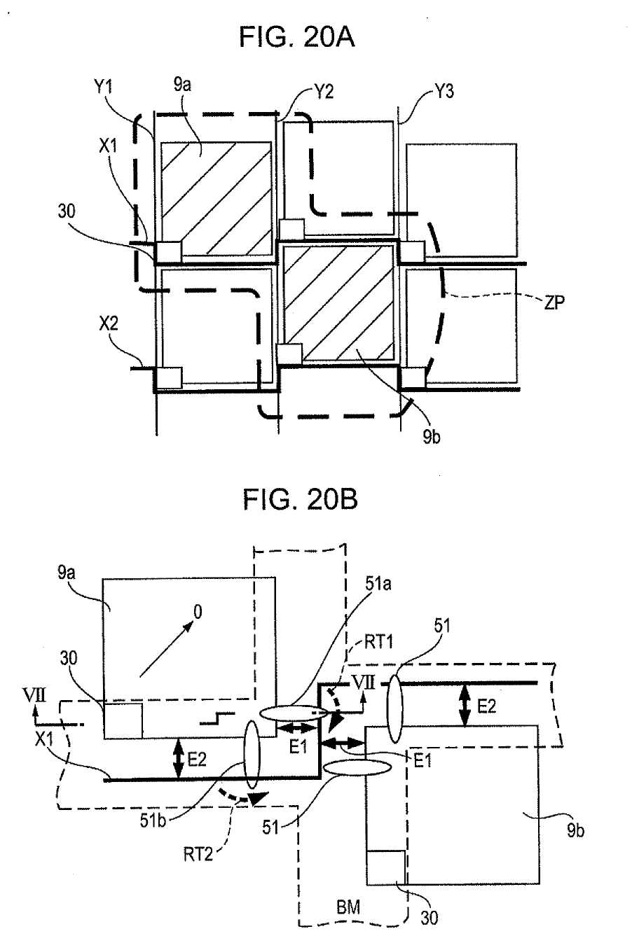

FIGS. 20A and 20B are partially cutaway views of the pixel unit illustrated in FIG. 19. As illustrated in FIG. 20A, in the liquid crystal device of FIGS. 20A and 20B, a plurality of first pixel electrode arrays 9a (odd-numbered pixel electrode array), in which a plurality of pixel electrodes 9 are arranged in the arrangement direction of the data lines Y1 to Y3, and a plurality of second pixel electrode arrays 9b (even-numbered pixel electrode array) that is adjacent to the first pixel electrode array 9a in the arrangement direction of the scanning lines X1 and X2 are arranged on the inner surface of the array substrate in the arrangement direction of the scanning lines X1 and X2 in an alternate manner.

The second pixel electrode array 9b is disposed at a predetermined distance from the first pixel electrode array 9a in the arrangement direction of the data lines Y1 to Y3.

The scanning lines X1 and X2 are bent and extended in the arrangement direction of the data lines Y1 to Y3, following the arrangement of the pixel electrodes. For this reason, a plurality of bent portions is formed in the arrangement direction of the scanning lines X1 and X2. The bent portions correspond to portions that are bent at an approximately right angle along corner portions of the pixel electrodes 9a and 9b. The bent portions are disposed so as to be opposed to the corner portions of the pixel electrodes disposed at both sides of the scanning lines Y1 to Y3. More specifically, the bent portions include a bent portion that is opposed to two corner portions of the pixel electrode 9a of the first pixel electrode array 9a and a bent portion that is opposed to two corner portions of the pixel electrode 9b of the second pixel electrode array 9b. It should be noted that the bent portions are not limited to a portion that is bent at a right angle and may be a portion that is bent at an obtuse angle or an acute angle and in a curved shape.

Here, the scanning lines X1 and X2 include straight-line portions that extend in their arrangement direction and connecting portions that connect the respective straight-line portions to each other. The positions of the straight-line portions alternate at a predetermined interval in the arrangement direction (a direction intersecting the scanning lines) of the data lines Y1 to Y3 with the connecting portions disposed between them.

The bent portions of the pixel electrode 9a of the first pixel electrode array are composed of the straight-line portions and the connecting portions. The bent portions of the pixel electrode 9b of the second pixel electrode array are composed of the straight-line portions and the connecting portions. In this manner, two bent portions alternate in the arrangement direction of the scanning lines X1 and X2, and the bent portions have a function of facilitating the alignment of the liquid crystals by means of a electric field generated between the opposite corner portions of the pixel electrode 9.

The liquid crystal device having such a configuration illustrated in FIG. 20A is in the splay alignment state when a voltage is not applied between the pixel electrode and the opposing electrode (or when a non-selection voltage is applied between them). As illustrated in FIG. 20B, when a voltage is applied to the pixel electrode 9a, since the pixel electrode 9b and the scanning line X1 have different potential levels, a horizontal electric field E1 is generated between the corner portions of the pixel electrode 9a and the bent portions of the scanning line X1 opposite the corner portions. That is, the horizontal electric field E1 is generated in a direction intersecting the scanning line direction of the pixel electrode 9, and a horizontal electric field E2 is generated in a direction intersecting the data line direction.

A rubbing direction of the alignment film is identical to the arrow 0 direction in FIG. 201. When a voltage is applied in such an initial alignment state under the condition described above, the alignment of a liquid crystal molecule 51a is twisted in a clockwise direction RT1 in accordance with the horizontal electric field E1, and the alignment of a liquid crystal molecule 51b is twisted in a counterclockwise direction RT2 in accordance with the horizontal electric field E2. By the liquid crystal molecules that are aligned in accordance with the horizontal electric fields E1 and E2, a disclination line is generated due to an alignment error in the vicinity of the corner portions of the pixel electrodes 9a and 9b and in the vicinity of the bent portions of the scanning line X1 opposite the corner portions. As a result, the liquid crystal molecules that are aligned by the effect of the horizontal electric fields E1 and E2 function as a bend transition nucleus, and the bend alignment is expanded to the peripheries of the liquid crystal molecules.

Moreover, even when the liquid crystal molecules that are aligned by the effect of the horizontal electric fields E1 and E2 generated in a direction that does not follow a desired bend alignment are present in the vicinity of the corner portion of the pixel electrodes and the bent portions of the scanning line X1, since a non-illustrated light shielding layer described above is formed on the non-display region, they do not have influence on the pixel display.

In this manner, the liquid crystal device illustrated in FIGS. 20A and 20B is configured such that the positions of the pixel electrodes 9 in the first pixel electrode array 9a and the second pixel electrode array 9b are alternately arranged at a predetermined distance in the arrangement direction of the data lines Y1 to Y3. Moreover, a plurality of bent portions that is bent in a crank shape is provided to the scanning lines X1 and X2 that are formed in the non-display region, following the arrangement of the pixel electrodes 9a and 9b. The plurality of bent portions of the scanning lines X1 and X2 is opposed to at least two corner portions that are disposed at both sides of the scanning lines X1 and X2. Therefore, it is possible to generate the horizontal electric field E2 between the pixel electrodes and the bent portions during voltage application in a complicated manner.

In this way, a plurality (two in the embodiment) of bend transition nucleus generation points can be provided in each pixel region ZP. Therefore, during voltage application, the entire liquid crystal molecules 51 in the image display region can transition from the splay alignment state to the bend alignment state in a more efficient manner than a liquid crystal device in which the scanning lines X1 and X2 are not bent. Therefore, a light transmission rate of a liquid crystal layer can be changed quickly, and thus a fast response speed can be provided. Moreover, an image lag does not occur and thus excellent display quality can be provided. The cross-sectional device structure taken along the line VII-VII in FIG. 20B is identical to that illustrated in FIG. 7.

The configuration described above is merely an exemplary configuration that can generate a strong horizontal electric field, and in no way, limits the scope of the invention.

### Embodiment 5

Next, an electronic apparatus using the OCB-mode liquid crystal device according to the present invention will be described. The present embodiment will be described by way of an example of a mobile phone.

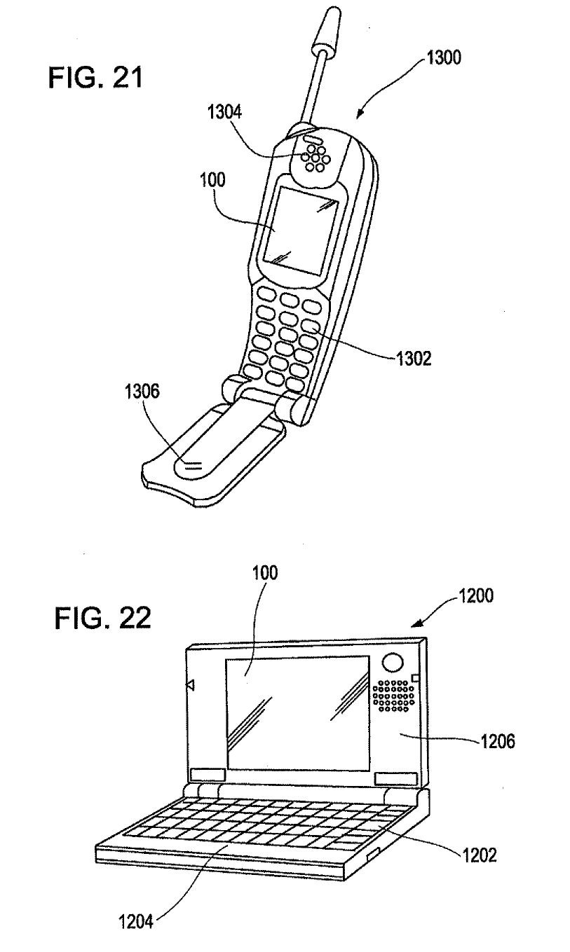

FIG. 21 is a perspective view illustrating an overall configuration of a mobile phone. A mobile phone 1300 mainly includes a casing 1306, an operation portion 1302 having a plurality of operation buttons, and a display portion on which still images, moving images, characters, and the like are displayed. The display portion has mounted thereon the liquid crystal device 100 according to the first to third embodiments.

As described above, the liquid crystal device according to the embodiments of the present invention has a simple configuration and can realize the initial sequence of the OCB-mode liquid crystals in a satisfactory manner. Therefore, the mobile phone 1300 having mounted thereon the liquid crystal device according to the embodiments of the present invention can provide an advantage such as small size and low cost.

### Embodiment 6

Next, the present embodiment will be described by way of an example of an information device (e.g., a personal computer). FIG. 22 is a perspective view of an information device (such as a PDA, a personal computer, a word processor) having mounted thereon the liquid crystal device of the present invention.

The information device 1200 includes an upper casing 1206, a lower casing 1204, an input portion 1202 such as a keyboard, and a display panel 100 using the OCB-mode liquid crystals of the present invention. The information device can provide the same advantage as that provided by the mobile phone.

This embodiment has been described above. It may be easily understood by those skilled in the art that various modifications can be made without departing from the new matter and the effects of the present invention. Therefore, such modifications are to fall within the scope of the present invention.

As described above, according to at least one of the embodiments of the present invention, it is possible to provide the following advantages. Although the following advantages do not occur at the same time, the enumeration of the following advantages should not be construed as unduly limiting the scope of the present invention.

### Advantage 1

Since the driving method of the OCB-mode liquid crystal device employs a driving method that follows the driving during a normal operation and that does not require application of an excessively high voltage and complex processing, it is possible to maintain consistency in the driving method, reduce the load to the liquid crystal driver, and reduce the cost. Moreover, since it is possible to obviate the need for a special process completely different from that of the normal operation to be performed for the initial sequence, it is possible to improve the usability of the OCB-mode liquid crystal devices.

### Advantage 2

Since the bend transition nucleus is generated by means of the horizontal electric field generated between the scanning lines and the pixel electrodes, and thereafter, the bend transition expansion is performed by means of the vertical electric field generated between the pixel electrodes and the opposing electrodes, the bend transition nucleus generation and the bend transition expansion can be implemented in a simple manner.

### Advantage 3

When the horizontal electric field is generated using the non-selected ones of the scanning lines, the long non-selection period of the scanning lines can be effectively used; therefore, a strong horizontal electric field can be applied to the OCB-mode liquid crystals for a longer time. Moreover, when the horizontal electric field is applied to the OCB-mode liquid crystals even during the selection period of the scanning lines, a localized horizontal electric field can be always (i.e., continuously) applied to the OCB-mode liquid crystals during the bend transition nucleus generation sequence. Therefore, the bend transition nucleus generation can be implemented in an excessively efficient manner. At this time, by setting the potential difference during the non-selection period so as to be larger than the potential difference during the selection period, a stronger horizontal electric field can be applied during the long non-selection period. Moreover, the strong horizontal electric field during the non-selection period can be generated by application of voltages of opposite polarities to the pixel electrodes and the non-selected ones of the scanning lines, respectively (however, the present invention is not limited to this). Therefore, the strong horizontal electric field can be generated in a satisfactory manner.

### Advantage 4

Since the potential difference between the pixel electrodes and the opposing electrodes is zero during the bend transition nucleus generation, the horizontal electric field is not generated. Therefore, only the strong horizontal electric field can be applied to the liquid crystal layer (OCB-mode liquid crystals), and thus the bend transition nucleus can be generated in a reliable manner.

### Advantage 5

The circuit can be configured using transistors capable of operating at a voltage as high as about 11 V, for example. Therefore, a liquid crystal driver does not need to equip a high-voltage device, and thus during manufacture of a driver IC, it is possible to obviate problems such as greater occupation space, complicated manufacturing process, and increased cost.

### Advantage 6

The vertical electric field is preferably set to zero when the horizontal electric field is generated. In such a case, the disclination (bend transition nucleus) can be generated in an efficient manner by means of the complicated, strong horizontal electric field.

### Advantage 7

Since voltages of opposite polarities are applied to the scanning lines and the pixel electrodes, respectively, when generating the horizontal electric field, a potential difference corresponding to the sum of the absolute values of both voltages is generated, whereby a strong horizontal electric field can be generated in a satisfactory manner.

### Advantage 8

Since the initial sequence can be executed in an efficient manner by changing the levels and application timings of voltages to the scanning lines, the data lines, and the common lines (the opposing electrodes), it is not necessary to add any special-purpose driver or the like,

### Advantage 9

It is possible to implement the initial sequence without requiring application of an excessively high voltage. It is also possible to implement the initial sequence by means of the same sequential driving method (e.g., a line sequential driving method and a multiline sequential driving method) as that of a normal operation. It is, therefore, possible to simplify a liquid crystal driving circuit and to thus decrease the cost of the OCB-mode liquid crystal device.

### Advantage 10

It is possible to implement a reasonable driving method that provides satisfactory results through a series of sequences: the bend transition nucleus generation sequence and the bend transition expansion sequence.

### Advantage 11

It is possible to improve the usability of the OCB-mode liquid crystal device and to thus facilitate the mass-production and popularization of the OCB-mode liquid crystal device.

In this way, the present invention provides an advantage that the initial sequence of the OCB-mode liquid crystals can be implemented by means of the same sequential driving as that of a normal operation without requiring application of an excessively high voltage (however, the present invention is not limited to the OCB-mode liquid crystals and can be similarly applied to liquid crystals that require the same transition sequence). Therefore, the present invention can be suitably used as a liquid crystal device, a driving method of a liquid crystal device, an IC (an integrated circuit device) for driving a liquid crystal device, and an electronic apparatus.

The entire disclosure of Japanese Patent Application Nos: 2007-226376, filed Aug. 31, 2007 and 2007-242288, filed Sep. 19, 2007 are expressly incorporated by reference herein.

What is claimed is:

1. A liquid crystal device including a first substrate and a second substrate disposed in a mutually opposing relationship and liquid crystals sandwiched between the first substrate and the second substrate, in which an initial sequence is executed, whereby an alignment state of molecules of the liquid crystals transitions from a splay alignment state to a bend alignment state to thereby perform display or light modulation, the liquid crystal device comprising:
a plurality of scanning lines and a plurality of data lines formed on the first substrate so as to intersect each other;
a pixel circuit including switching elements formed at intersections of the plurality of scanning lines and the plurality of data lines, pixel electrodes connected to the switching elements, and sustain capacitors for temporarily sustaining voltages of the pixel electrodes;
opposing electrodes formed on the second substrate opposite the pixel electrodes;
a driver capable of driving the scanning lines, the data lines, and the opposing electrodes; and
a control unit configured to supply a control signal and an image signal for the display or the light modulation,
wherein the initial sequence includes a bend transition nucleus generation sequence and a bend transition expansion sequence,
wherein a horizontal electric field is generated by a potential difference between the pixel electrodes and the scanning lines during execution of the bend transition nucleus generation sequence, and
wherein a vertical electric field is generated by a potential difference between the pixel electrodes and the opposing electrodes during execution of the bend transition expansion sequence.

2. The liquid crystal device according to claim 1,
wherein during execution of the bend transition nucleus generation sequence, a voltage is applied to the scanning lines so that the switching elements of the pixel circuit are turned on, and a voltage different from the voltage applied to the scanning lines is applied to the data lines, and
wherein during execution of the bend transition expansion sequence, different voltages are applied to the data lines and the opposing electrodes, respectively.

3. The liquid crystal device according to claim 1, wherein during execution of the bend transition nucleus generation sequence, a horizontal electric field is generated by a potential difference between the pixel electrodes and non-selected ones of the scanning lines.

4. The liquid crystal device according to claim 3, wherein during execution of the bend transition nucleus generation sequence, a horizontal electric field is generated by a potential difference between the pixel electrodes and selected ones of the scanning lines.

5. The liquid crystal device according to claim 4, wherein the potential difference between the pixel electrodes and the non-selected ones of the scanning lines is larger than the potential difference between the pixel electrodes and the selected ones of the scanning lines.

6. The liquid crystal device according to claim 1, wherein the liquid crystals are OCB-mode (optically compensated bend mode) liquid crystals.

7. The liquid crystal device according to claim 1, wherein during execution of the bend transition nucleus generation sequence, identical voltages are applied to the data lines and the opposing electrodes, respectively, so that a vertical electric field is not generated between the pixel electrodes and the opposing electrodes.

8. The liquid crystal device according to claim 1, wherein during execution of the bend transition nucleus generation sequence, voltages having opposite polarities relative to a predetermined potential are applied to the pixel electrodes and the scanning lines, respectively.

9. The liquid crystal device according to claim 1, wherein during execution of the initial sequence, the scanning lines are driven in a sequential manner.

10. The liquid crystal device according to claim 9,
wherein the sequential driving employs any one of the following methods:
a line sequential driving method wherein the scanning lines are sequentially driven on a one-by-one basis;
a multiline sequential driving method wherein the scanning lines are sequentially driven in units of multiple lines of the scanning lines that are simultaneously selected; and
a field sequential driving method wherein the entire scanning lines are simultaneously driven.

11. The liquid crystal device according to claim 1, wherein the bend transition nucleus generation sequence is executed repeatedly over a plurality of frame periods.

12. The liquid crystal device according to claim 1, wherein the bend transition expansion sequence is executed repeatedly over a plurality of frame periods.

13. The liquid crystal device according to claim 1,
wherein the bend transition nucleus generation sequence is executed repeatedly over a predetermined plurality of frame periods,
wherein the bend transition expansion sequence is executed repeatedly over a predetermined plurality of frame periods, and
wherein a repetition period of the bend transition expansion sequence is set longer than a repetition period of the bend transition nucleus generation sequence.

14. A driving method of a liquid crystal device including: a first substrate and a second substrate disposed in a mutually opposing relationship; liquid crystals sandwiched between the first substrate and the second substrate; a plurality of scanning lines and a plurality of data lines formed on the first substrate so as to intersect each other; a pixel circuit including switching elements formed at intersections of the plurality of scanning lines and the plurality of data lines, pixel electrodes connected to the switching elements, and sustain capacitors for temporarily sustaining voltages of the pixel electrodes; opposing electrodes formed on the second substrate opposite the pixel electrodes, in which an initial sequence is executed, whereby an alignment state of molecules of the liquid crystals transitions from a splay alignment state to a bend alignment state to thereby perform display or light modulation,
wherein the initial sequence includes a bend transition nucleus generation sequence and a bend transition expansion sequence,
wherein during the bend transition nucleus generation sequence,
a horizontal electric field is generated by a potential difference between the pixel electrodes and the scanning lines, whereby a bend transition nucleus is generated by means of the horizontal electric field, and
wherein during the bend transition expansion sequence,
a vertical electric field is generated by a potential difference between the pixel electrodes and the opposing electrodes, whereby bend transition is expanded by means of the vertical electric field.

15. The driving method of a liquid crystal device according to claim 14,
wherein during the bend transition nucleus generation sequence,
a first voltage of a first polarity is applied to the scanning lines so that the switching elements are turned on,
a second voltage of a second polarity opposite to the first polarity is applied to the data lines so that a potential difference corresponding to a difference between the first voltage and the second voltage is produced between the pixel electrodes and the scanning lines, thereby generating a horizontal electric field, and
the second voltage of the second polarity is applied to the opposing electrodes so that a potential difference is not produced between the opposing electrodes and the pixel electrodes, thereby preventing generation of a vertical electric field, and
wherein during the bend transition expansion sequence,
different voltages are applied to the data lines and the opposing electrodes, respectively, so that a vertical electric field is generated by a potential difference between the pixel electrodes and the opposing electrodes.

16. The driving method of a liquid crystal device according to claim 14, wherein during the bend transition nucleus generation sequence, a horizontal electric field is generated by a potential difference between the pixel electrodes and non-selected ones of the scanning lines, whereby a bend transition nucleus is generated by means of the horizontal electric field.

17. The driving method of a liquid crystal device according to claim 16,
wherein during the bend transition nucleus generation sequence,
a horizontal electric field is also generated by a potential difference between the pixel electrodes and selected ones of the scanning lines such that the potential difference between the pixel electrodes and the non-selected ones of the scanning lines is greater than the potential difference between the pixel electrodes and the selected ones of the scanning lines,
voltages having opposite polarities relative to a predetermined potential are applied to the pixel electrodes and the non-selected ones of the scanning lines, respectively, and
a vertical electric field is not generated between the pixel electrodes and the opposing electrodes.

18. The driving method of a liquid crystal device according to claim 14,
wherein during the initial sequence, the scanning lines are driven in a sequential manner,
wherein the bend transition nucleus generation sequence is executed repeatedly over a predetermined plurality of frame periods,
wherein the bend transition expansion sequence is executed repeatedly over a predetermined plurality of frame periods, and
wherein a repetition period of the bend transition expansion sequence is set longer than a repetition period of the bend transition nucleus generation sequence.

19. An integrated circuit device for driving a liquid crystal device that execute the driving method of a liquid crystal device according to claim 14, the integrated circuit device comprising:
a driver capable of driving the scanning lines, the data lines, and the opposing electrodes; and
a control unit configured to supply a control signal and an image signal for the display or the light modulation.

20. An electronic apparatus comprising the liquid crystal device according to claim 1.
